(19) United States
(12) Patent Application Publication
(10) Pub. No.: US 2018/0156907 A1
(43) Pub. Date: Jun. 7, 2018

(54) ECHO MEASUREMENT

(71) Applicant: IMPERIAL INNOVATIONS LIMITED, London (GB)

(72) Inventors: Frederic Bert CEGLA, London (GB); Julio Agustin Isla GARCIA, London (GB)

(21) Appl. No.: 15/578,359

(22) PCT Filed: Jun. 21, 2016
(86) PCT No.: PCT/GB2016/051852

§ 371 Date: Nov. 30, 2017

(30) Foreign Application Priority Data
Jun. 22, 2015 (GB) 1510945.7
Mar. 10, 2016 (GB) 1604134.5

(51) Int. Cl. G01S 13/22; G01S 15/10; G01S 17/10

(52) U.S. Cl. CPC G01S 13/22; G01S 17/10; G01S 15/105

(57) ABSTRACT

An echo measurement system transmits a transmitted-signal which is modulated over a period of time corresponding to a modulation duration. The modulation could be, for example, modulation to represent a coded signal. A transducer (2), which may be common between transmission and reception, receives a received-signal which is cross-correlated with the transmitted-signal. The transmitted-signal comprises a plurality of transmission periods separated by a plurality of transmission pauses. The modulation duration extends over two or more of the transmission periods and the duration of the transmission pauses is varied within a range of transmission pause duration. The technique seeks to improve the signal-to-noise ratio without imposing undesirable other constraints.

This invention relates to the field of echo measurement.

It is known to use echo measurement in fields such as, for example, geophysics, electromagnetic signal measurements, acoustic signal measurements, medical ultrasound and industrial ultrasound. In such systems pulse-echo mechanisms may transmit a high power tone-burst signal while a receive amplifier is turned off. After the signal transmission has been completed, the receive amplifier is switched on and the reflected waves are recorded. The usefulness of such techniques is typically limited by the signal-to-noise ratio associated with the transmission and reception mechanisms.

One way to improve the signal-to-noise ratio is to increase the power of the transmitted-signal. However, in some circumstances, the power of the transmitted-signal which may be used is limited by intrinsic safety concerns (e.g. regulation), limitations of the electronic and transducer hardware, and/or limitations in the signal amplitude that can be sustained by the signal propagation medium itself (e.g. the onset of cavitation in liquids and tissue).

Another way of improving the signal-to-noise ratio is to employ averaging whereby several lower power tone-bursts are transmitted and the received-signals are averaged at the receiver. A problem with this technique is that there must be a pause longer than the time the reflected signal takes to travel from the furthest reflector between the transmission of consecutive tone-bursts and any reverberations need to have died out before the next transmission is started. In order to increase the signal-to-noise ratio substantially, many averages are required and so the need for the relatively long pause between tone-bursts has the result that averaging takes a long time. This has the effect of limiting the application of averaging to situations where the reflected signals are not expected to change significantly with time, e.g. where the reflector is not moving or the propagation medium is not likely to change properties (such as temperature).

Another technique which may be used to improve signal-to-noise ratio is that of pulse-compression whereby a longer coded signal (e.g. a coded sequence or a chirp-signal) is transmitted and this is cross-correlated with the received-signal. A problem with this technique is that the improvement in the signal-to-noise ratio is generally proportional to the length of the coded sequence that is sent. However, the sequence length is limited by the distance of the closest reflector from the transducer/antenna, because it is not generally possible to send and receive from the same transducer/antenna, or closely located receiver and transmitter at the same time.

Viewed from one aspect the present disclosure provides a method of echo measurement comprising:

transmitting a transmitted-signal modulated over a modulation duration;

receiving a received-signal; and

cross correlating said received-signal with said transmitted-signal, wherein said transmitting comprises a plurality of transmission periods separated by a plurality of transmission pauses;

said modulation duration extends over two or more of said plurality of transmission periods; and

duration of said transmission pauses is varied within a range of transmission pause duration.

The technique recognizes that by providing transmission pauses in the transmitted-signal (outbound signal) with these transmission pauses varying in length, received-signals (inbound signals) which have been in flight for varying amounts of time may be received. Thus, as a consequence of the variation in the transmission pause duration, received-signals having a range of time of flight will be received even though at any given instant the received-signal of a given time of flight may fall within a period at which the transmitting signal is being sent such that a particular received-signal is lost. The variation of the transmission pause duration moves the reception window around within a range of time of flight values for the received-signal such that over time received-signals from a broader range of time of flight may be received.

The cross-correlation performed that matches modulation of the transmitted-signal with modulation of the received-signal may determine a variety of different characteristics of the waveform of the received-signal. In some circumstances the cross correlation may determine the time of flight of the received-signal as a form of range finding. In other embodiments, either in combination with time of flight measurement, or as an alternative thereto, the amplitude of the received-signal or the phase of the received-signal may be determined in order to derive characteristics of, for example, a reflecting object (e.g. object/defect detection, object/defect sizing, object/defect characterization, thickness measurement, surface roughness etc).

The use of transmission pauses within which the received-signal can be received enables in some embodiments the modulation duration to be greater than a minimum within a measured range of time of flight or greater than the time it takes for the signals to travel to the nearest detectable object/defect. As an example, this may permit a coded sequence length (corresponding to a modulation duration) to be greater than a desired minimum time of flight thereby permitting an increase in the signal-to-noise ratio.

The present techniques are useful when the transmitting and the receiving are performed spatially proximate to one another as in these circumstances typically receiving cannot be performed whilst transmission is taking place. In some embodiments, the transmitting and the receiving may be performed by a common transducer with reception taking place when the common transducer is not transmitting.

The transmitted-signal may be modulated in a variety of different ways. In some embodiments the transmitted-signal may be modulated in accordance with a coded sequence with this sequence having an overall modulation duration (code sequence length) which extends over two or more transmission periods. In other embodiments the transmitted-signal may be modulated as a chirp signal using chirp modulation with a duration of the chirp extending over two or more transmission periods.

It will be appreciated that the transmitted-signal can be modulated, such as to send a coded signal, in a wide variety of different ways including frequency modulation, amplitude modulation and/or phase modulation. One example modulation is binary phase-shift keying (BPSK) modulation where the polarity of each transmission period with N cycles and frequency F is controlled by a binary sequence. The amplitude envelope of each transmission period may be apodized to control the bandwidth of the transmitted-signal. The code sequences may, for example, be Golay codes, Barker codes, M sequences, random sequences, pseudo-random sequences or other codes.

While the present techniques may be used to provide a single channel of detection, the techniques are well suited for transmitting a plurality of orthogonally modulated transmission signals which in turn result in a plurality of received-signals thereby providing a cross product of independent measurement channels. It is possible that the transmission and the reception for these independent channels may be performed using common transducers.

The transmitted-signal can have a variety of different physical forms. In some embodiments the transmitted-signal may be an acoustic wave signal. In other embodiments the transmitted-signal may be an ultrasound signal or an electromagnetic signal.

The duration of the transmission pauses is varied within a range of transmission pause duration. Within this range of transmission pause duration, the duration of the transmission pause is maybe varied in a variety of different ways, such as randomly or in accordance with a predetermined sequence.

Viewed from another aspect the present disclosure provides apparatus for echo measurement comprising:

a transmitter to transmit a transmitted-signal modulated over a modulation duration;

a receiver to receive a received-signal; and

correlation circuitry to cross correlate said received-signal with said transmitted-signal, wherein

said transmitter is configured to transmit during a plurality of transmission periods separated by a plurality of transmission pauses;

said modulation duration extends over two or more of said plurality of transmission periods; and

duration of said transmission pauses is varied within a range of transmission pause duration.

Viewed from a further aspect the present disclosure provides apparatus for echo measurement comprising:

means for transmitting a transmitted-signal modulated over a modulation duration;

means for receiving a received-signal; and

means for cross correlating said received-signal with said transmitted-signal, wherein

said means for transmitting is configure to transmit during a plurality of transmission periods separated by a plurality of transmission pauses;

said modulation duration extends over two or more of said plurality of transmission periods; and

duration of said transmission pauses is varied within a range of transmission pause duration.

Example embodiments will now be described, by way of example only, with reference to the accompanying drawings in which:

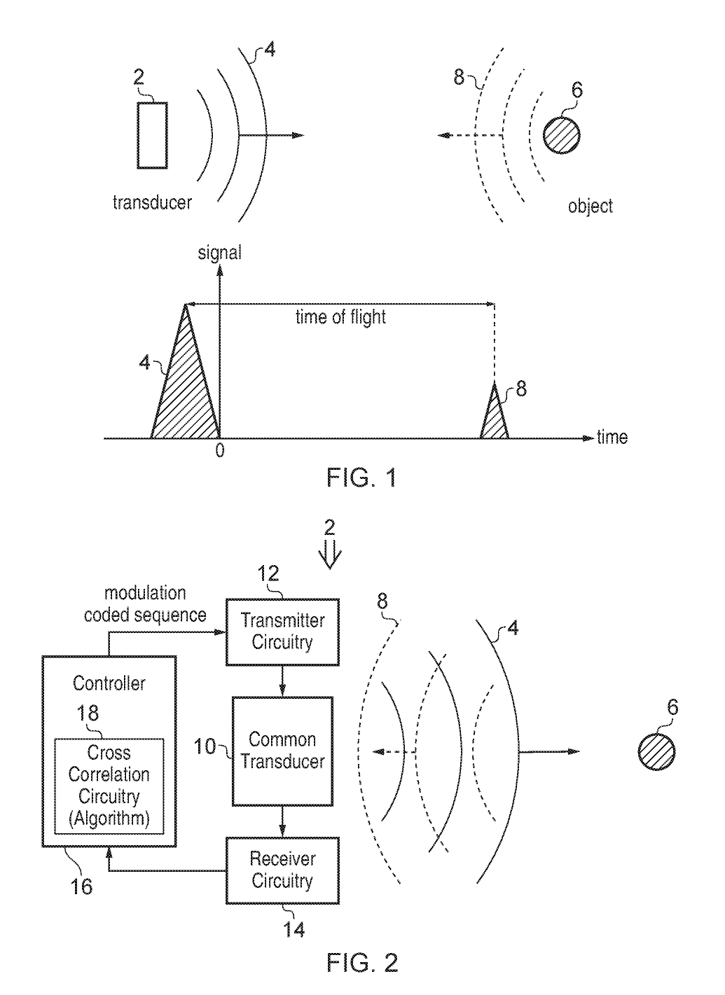

FIG. 1 schematically illustrates an echo measurement technique;

FIG. 2 schematically illustrates an echo measurement technique employing a common transducer and cross correlation of the received-signal with the transmitted-signal;

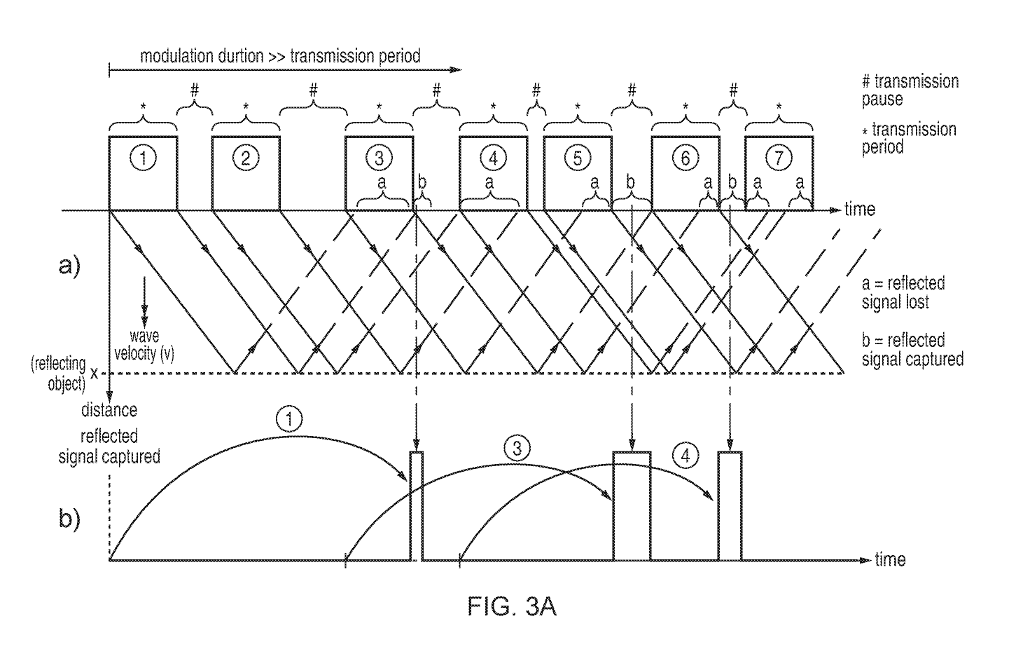

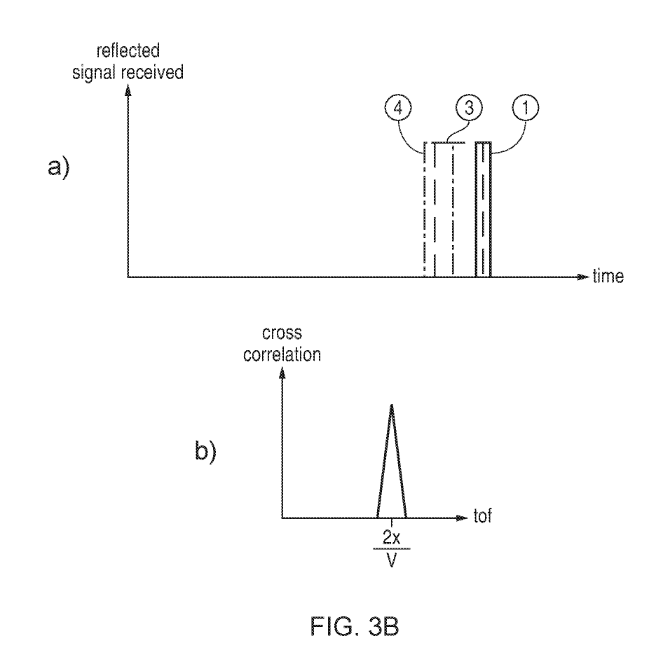

FIGS. 3A and 3B schematically illustrates operation of a system using a transmitted-signal formed of a plurality of transmission periods separated by transmission pauses of varying duration;

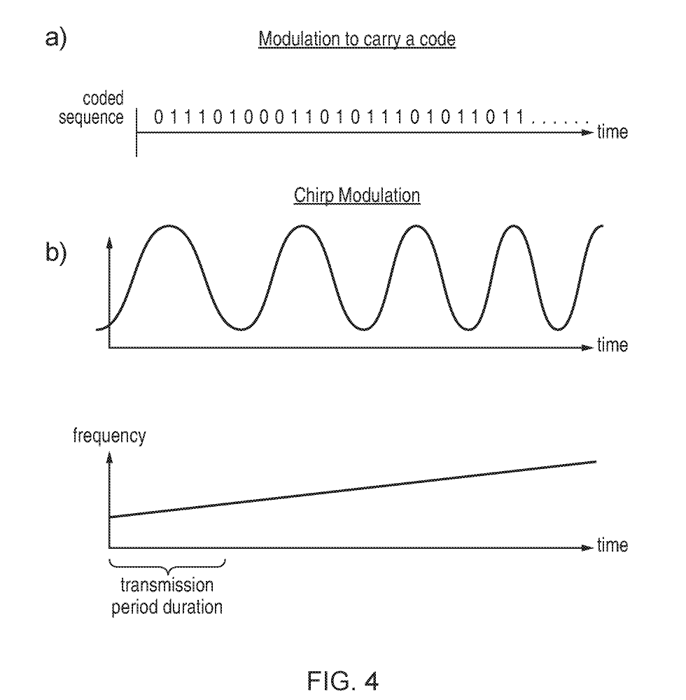

FIG. 4 schematically illustrates modulation to carry a coded sequence and chirp modulation;

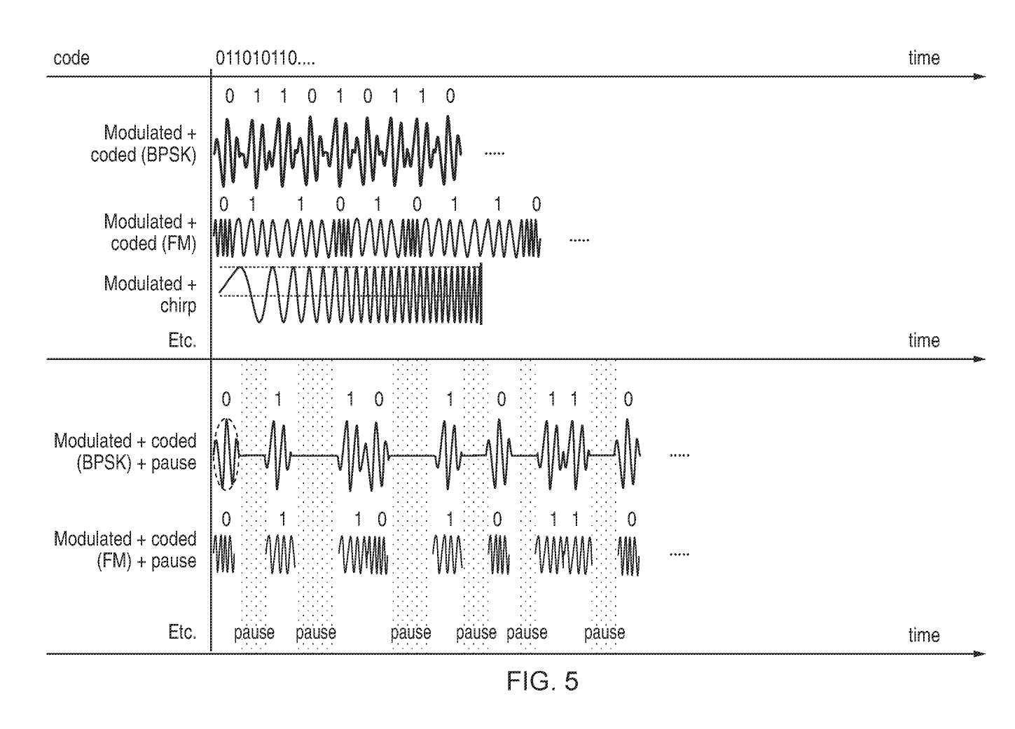

FIG. 5 schematically illustrates further example forms of modulation and coding;

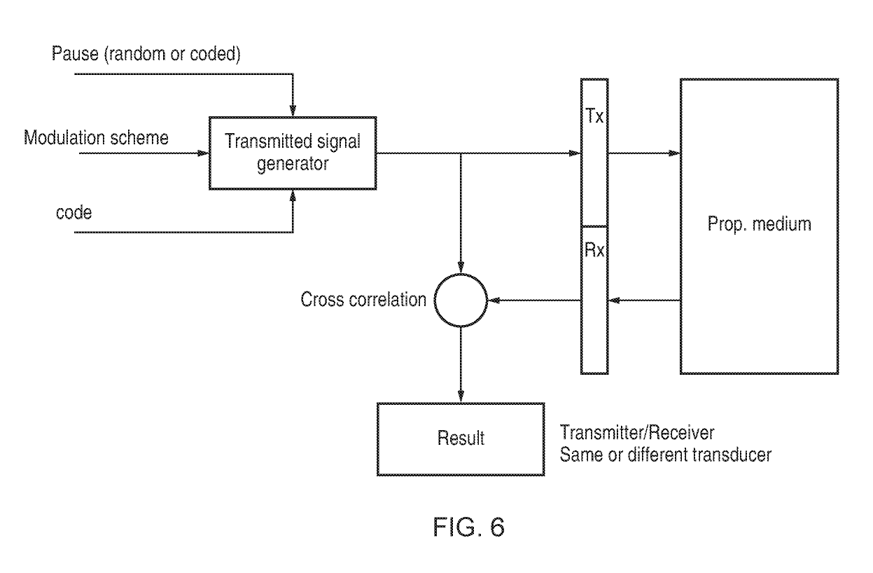

FIG. 6 schematically illustrates an example embodiment using a selectable modulation scheme to apply a code to a transmitted-signal;

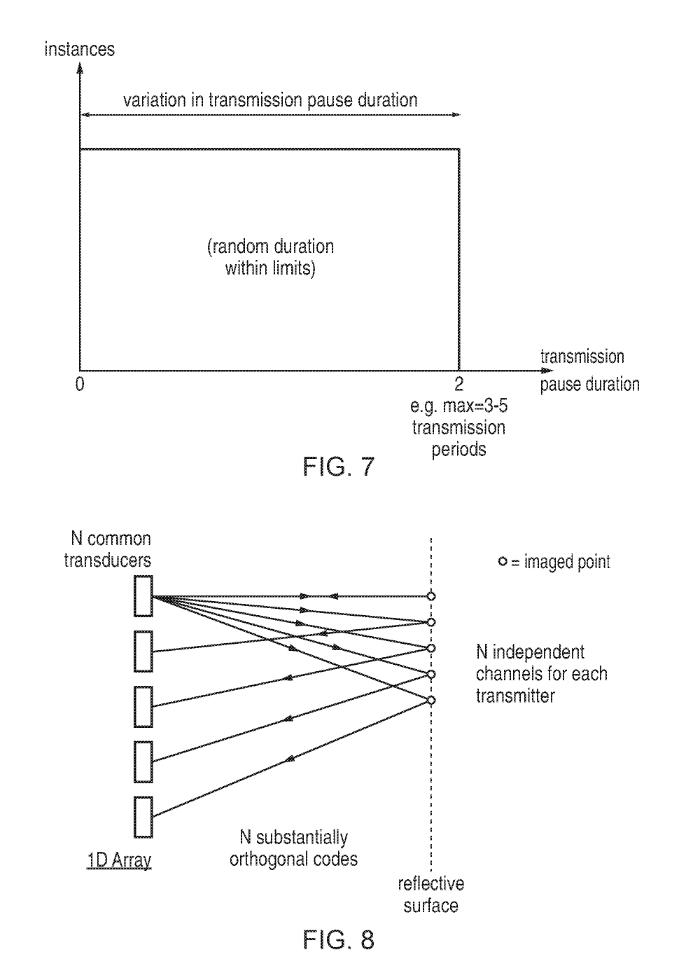

FIG. 7 schematically illustrates the variation of transmission pause duration within a range of transmission pause duration;

FIG. 8 schematically illustrates a 1D array of transducers providing a plurality of independent channels;

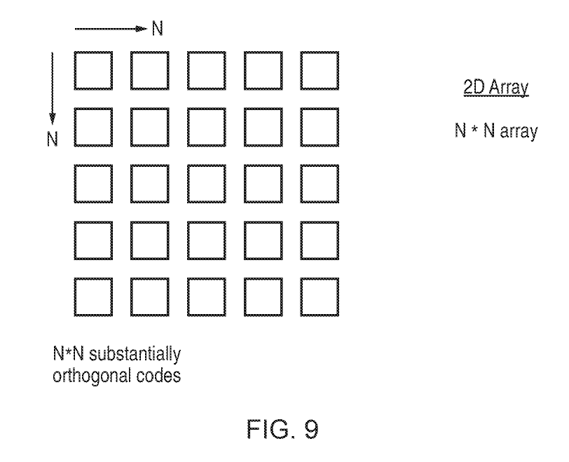

FIG. 9 schematically illustrates a 2D array of transducers providing a plurality of independent channels;

FIG. 10 schematically illustrates an acquisition system for 1 bit digitization of pulse echo signals;

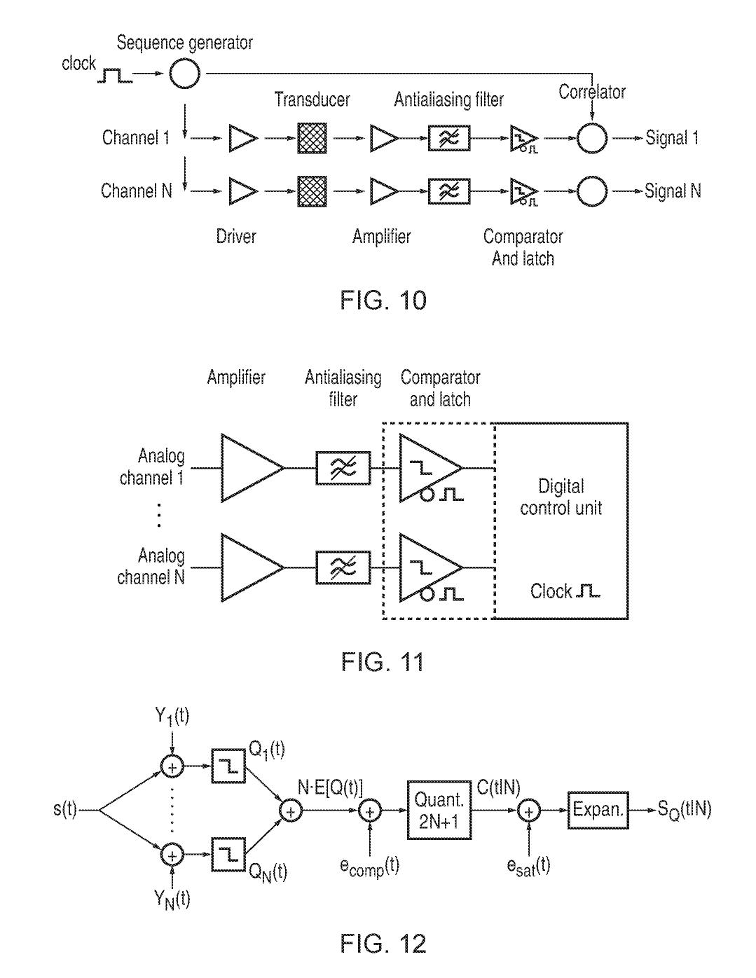

FIG. 11 schematically illustrates a N-channel binary acquisition system; the sampling frequency can be as high as the system clock frequency; external comparators and/or latches may not be necessary in some cases;

FIG. 12 schematically illustrates stages of binary quantisation; N repetitions are added after the comparator, which produces the expected value N·E[Q] with an error ecomp; this expected value is quantised and an entire number C_{N} is obtained; this operation may introduce a significant saturation error eₛₐₜ; the output of the quantiser have to be “expanded” to compensate the non-linear “compressing” behaviour of E[Q];

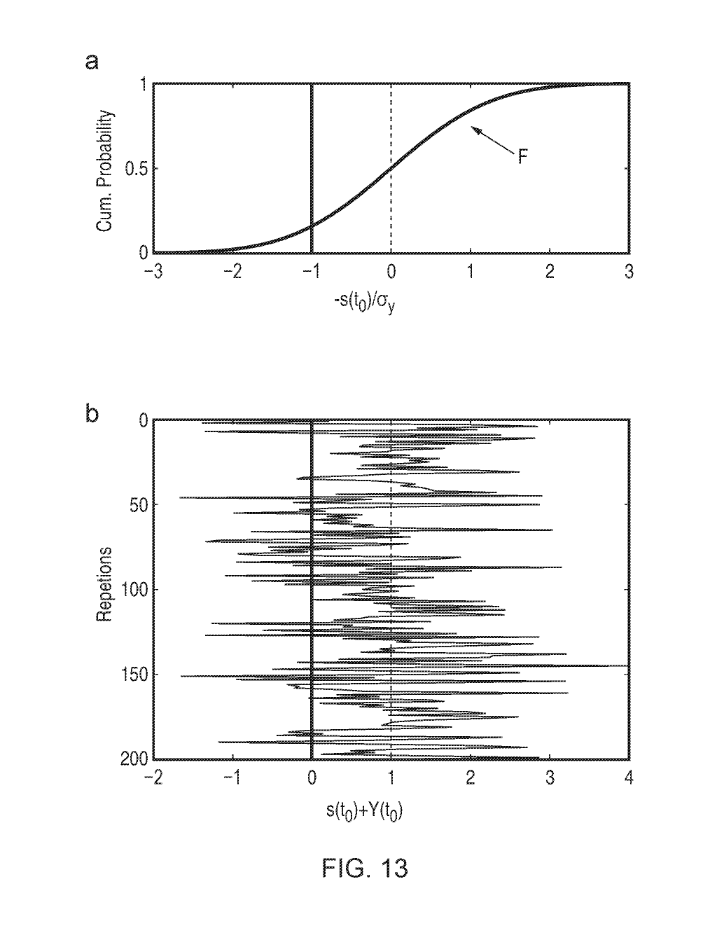

FIG. 13 schematically illustrates a) Cumulative distribution function (CDF) of the standard normal distribution, F. b) Repetitions of X (t₀) with s (t₀)=1; if the number of repetitions at either side of a certain level and their distribution are known, then the mean value of the distribution can be estimated relative to its standard deviation;

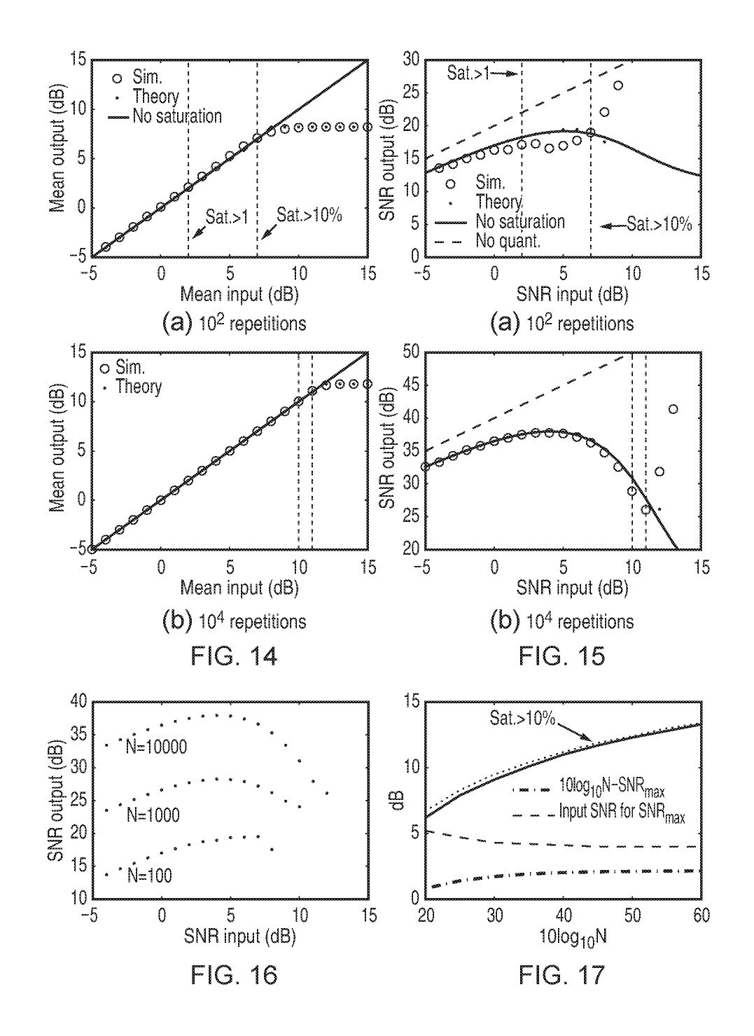

FIG. 14 schematically illustrates mean value before and after quantisation of a normal distribution with σ=1 for 10⁴ sets of a) 10² and b) 10⁴ samples; the continuous line represents the expected signal without saturation error; the vertical dotted line (Sat.>1) indicates the occurrence of saturation at least once with a probability of 10⁻⁴. The vertical dotted line (Sat.>10%) indicates the occurrence of saturation 10% of the time with a probability of 0:9.

FIG. 15 schematically illustrates SNR before and after quantisation. 10⁴ sets of a) 10² and b) 10⁴ repetitions; the continuous line represents the ex-pected SNR without saturation or rounding error; the vertical dotted line (Sat.>1) indicates the occurrence of saturation at least once with a probability of 10⁻⁴; the vertical dotted line (Sat.>10%) indicates the occurrence of saturation 10% of the time with a probability of 0.9; the dashed line is the resulting SNR without quantisation;

FIG. 16 schematically illustrates outputs of equation (12) for SNR inputs between −5 and 15 dB using 10⁴ sets of 10², 10³ and 10⁴ repetitions;

FIG. 17 schematically illustrates input SNR that yields SNRₘₐₓ (--), 10 log₁₀ N−SNRₘₐₓ (⋅-), and input SNR where saturation occurs 10% of the time with a probability of 0.9 (labelled Sat.>10%) vs. the number of added repetitions N; the dotted and continuous lines labelled Sat.>10% correspond to sets of 10 and 10⁴ samples;

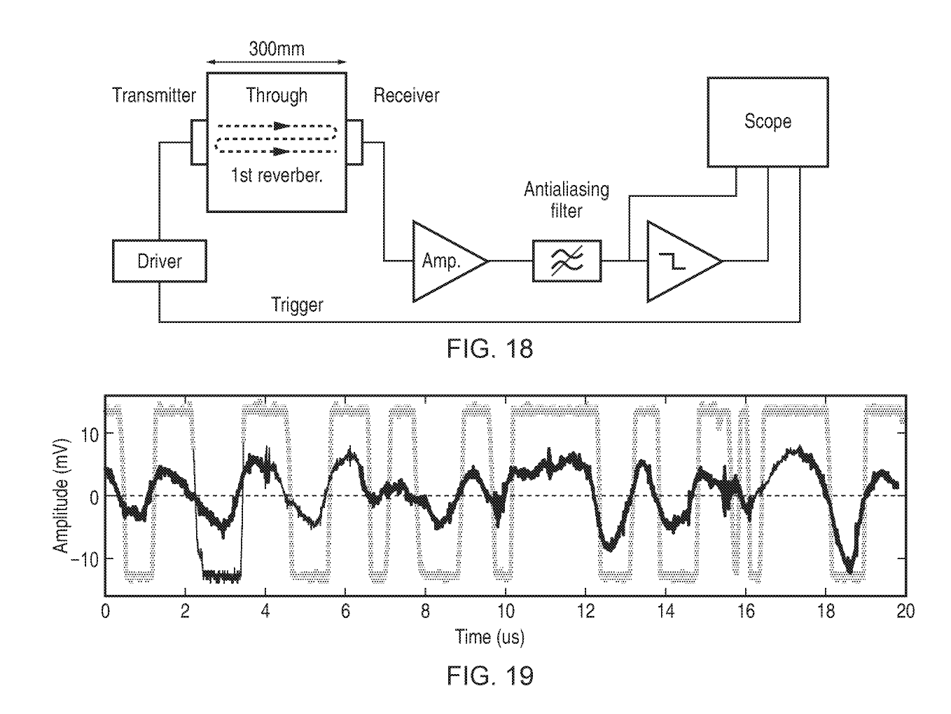

FIG. 18 schematically illustrates an experimental set-up with ultrasonic transducers; signals are recorded before and after the comparator and later averaged;

FIG. 19 schematically illustrates comparator input (black) and output (grey); the output has been normalised to fit the figure;

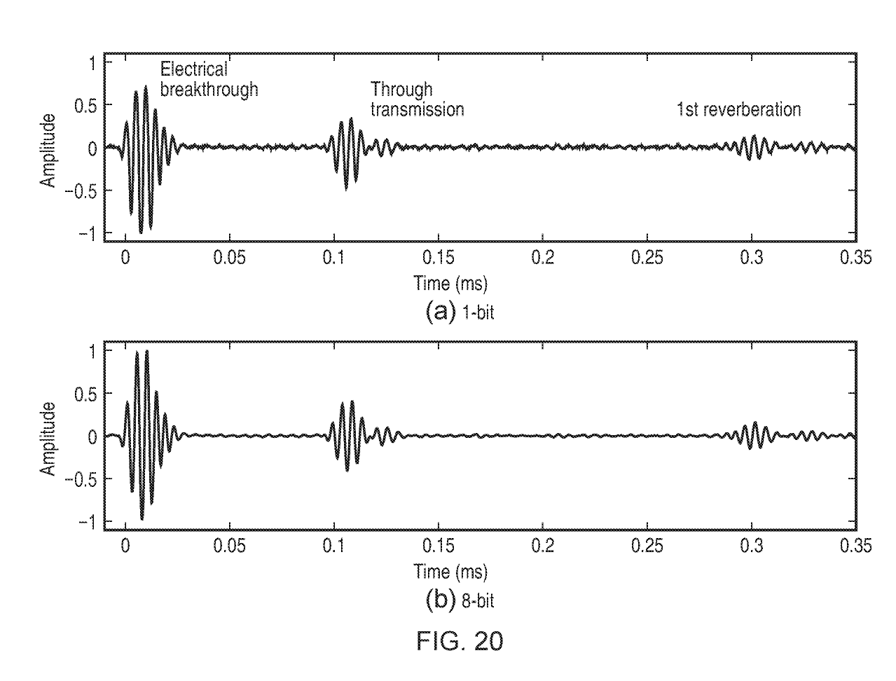

FIG. 20 schematically illustrates signals after 10⁶ averages: a) 1-bit quantisation. b) 8-bit quantisation (scope ADC); signals are normalised with respect to their maximum value;

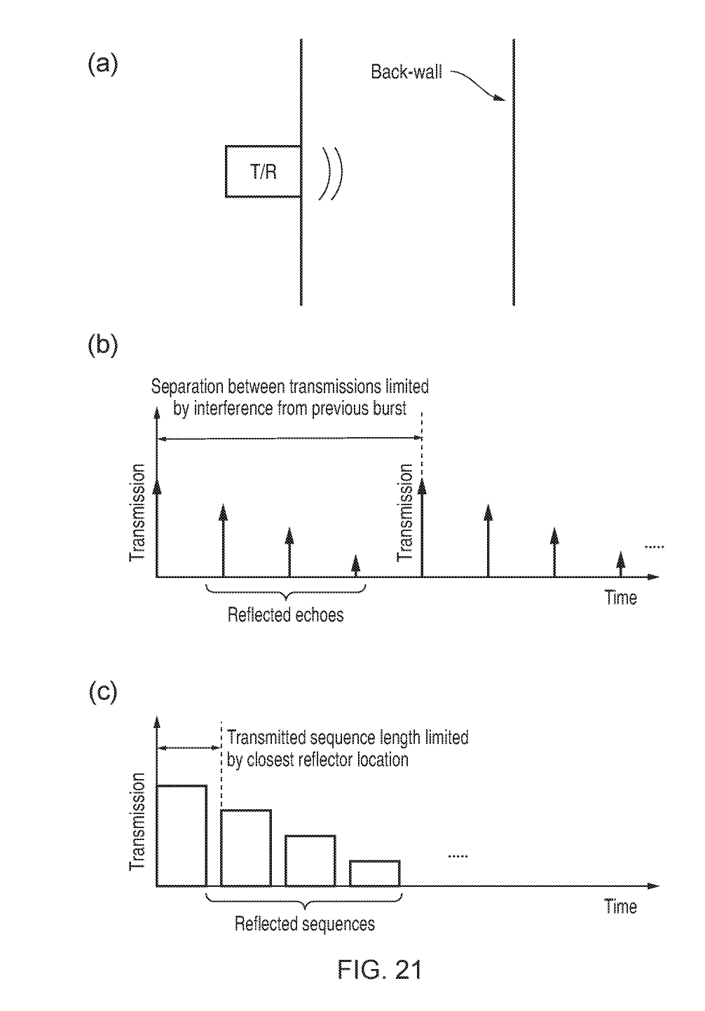

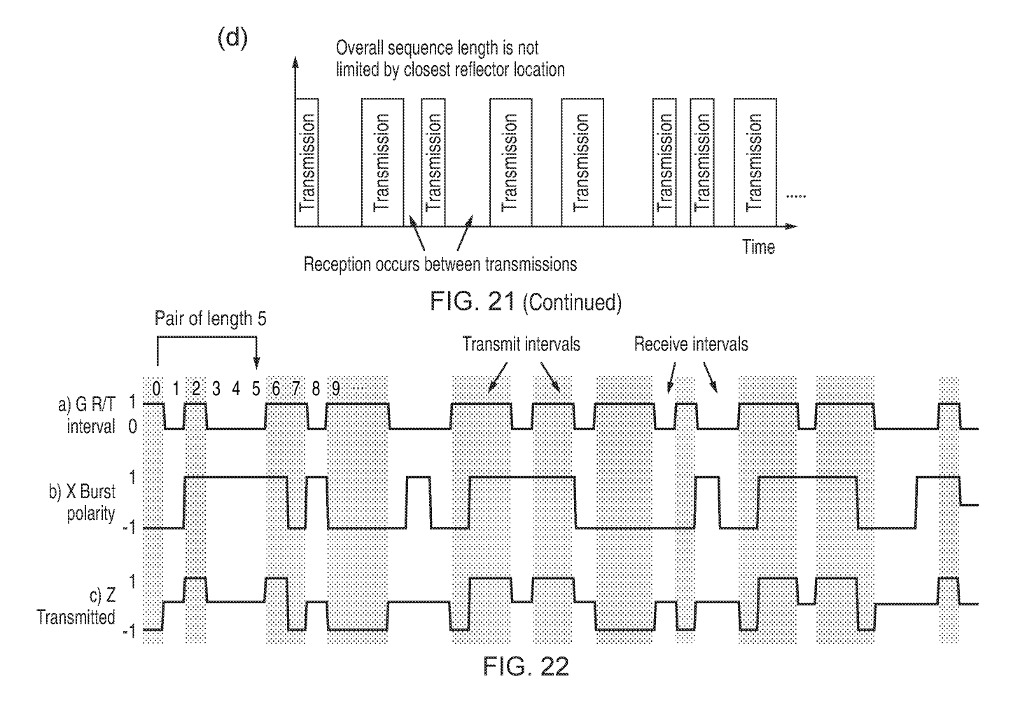

FIG. 21 schematically illustrates different types of excitation for pulse-echo transducers; a) Transducer operating in pulse-echo mode. b) Received signal when using averages. c) Received signals when using a sequence for pulse-compression. d) Proposed sequence with reception intervals;

FIG. 22 schematically illustrates an example of sequence construction with receive intervals; a) Sequence used to control the location of the gaps. b) Sequence used to set the polarity of the transmitted burst. c) Transmitted sequence;

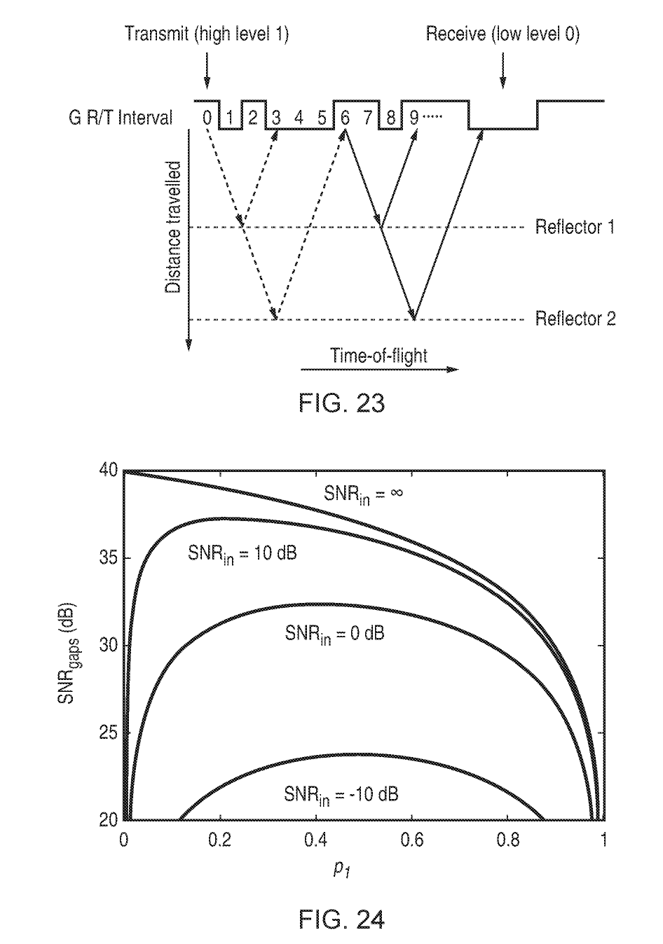

FIG. 23 schematically illustrates: random distribution of receive intervals in a sequence. A burst is sent in each transmit interval (sequence high level) and the reflected echo can be received only if its arrival time matches the occurrence of a receive interval (sequence low level);

FIG. 24 schematically illustrates SNR of the sequence with gaps, SNR_{gaps}, vs. the probability of having a transmit interval, p₁, for different input SNR, SNRᵢₙ; the total length of the sequence is set to L=10⁴.

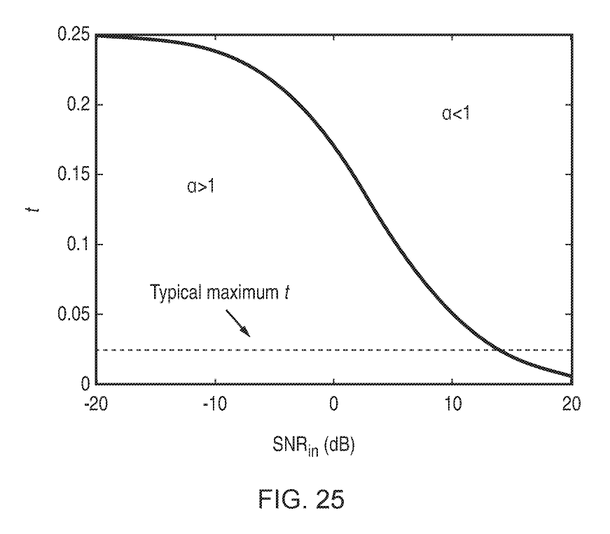

FIG. 25 schematically illustrates a ratio of transmit and total number of intervals, t, and input SNR, SNRᵢₙ, for which the SNR obtained after using the sequences with receive gaps is approximately the same to that of averaging, i.e. α≈1; for any combination of t and SNRᵢₙ values below the curve, α>1, and hence the sequences with receive intervals produce a greater SNR than averaging; the dashed grey curve shows a typical maximum value for t in practice;

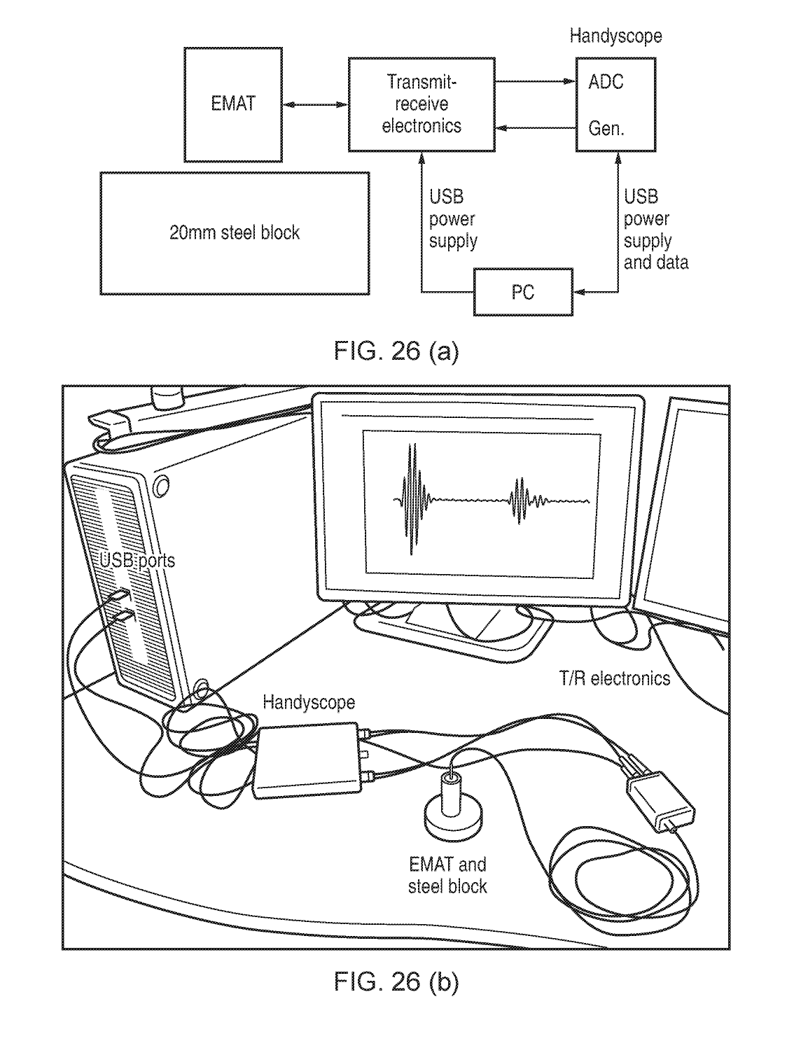

FIG. 26 schematically illustrates an experimental setup using low-power custom-made electronics and sequences with reception gaps to drive a com-mercial EMAT employing 4.5 Vpp only; a) Block diagram. b) Photograph of real setup; and

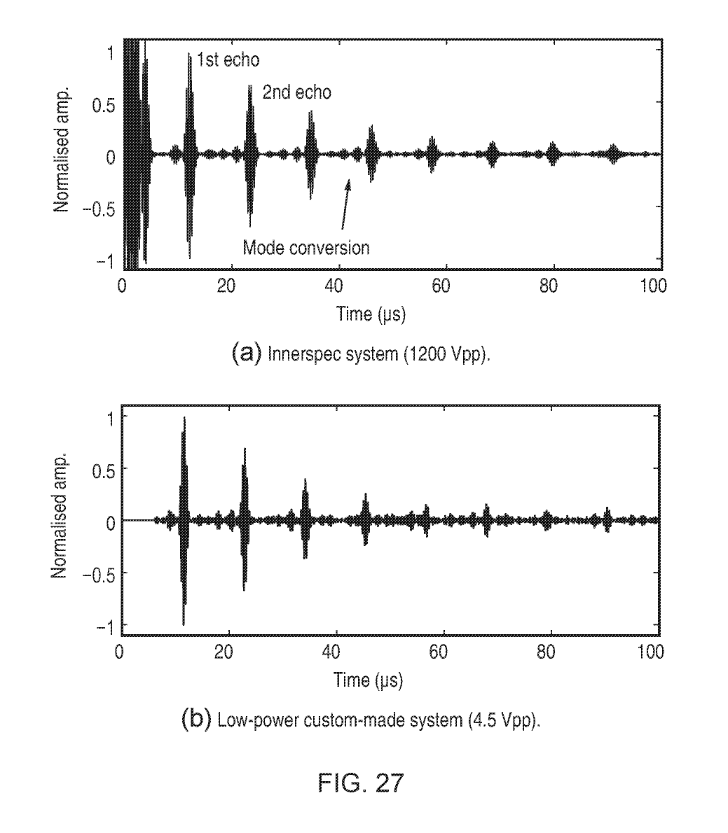

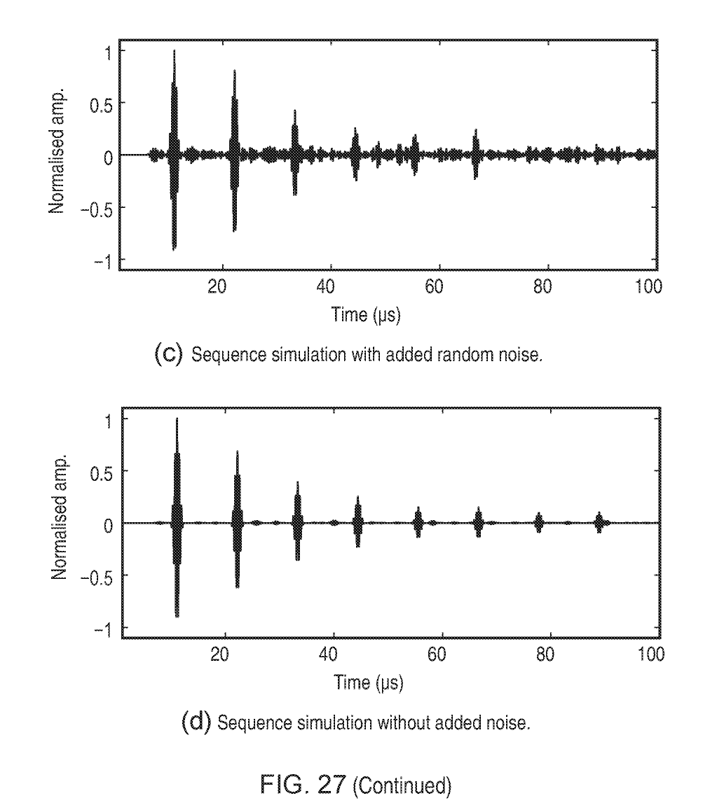

FIG. 27 schematically illustrates echoes from 20 mm-thick steel block; a) Signal from the Innerspec system (a state of the art commercial system) using 1200 Vpp excitation. b) Signal from custom-made electronics using a sequence with reception gaps. c) Simulated sequence with reception gaps and added random noise with a standard deviation 10 times greater than the signal. d) Simulated sequence with reception gaps without added noise.

FIG. 1 schematically illustrates pulse-echo measurement. A transducer 2 transmits a transmitted-signal 4, which may be in the form of an acoustic wave, an ultrasound signal, an electro-magnetic wave or some other form of radiation. The transmitted-signal 4 propagates outward from the transducer 2 toward a target object 6. The transmitted-signal is reflected from the target object 6 and returns as a reflected signal 8 toward the transducer 2. If the transducer 2 has ceased to transmit at the time that the reflected signal 8 arrives back at the transducer 2, then the reflected signal 8 will be detected by the transducer 2 as a received-signal. The graph in the lower portion of FIG. 1 schematically illustrates the transmission of the transmitted-signal 4 followed, after a time of flight for the signal between the transducer 2 and the target object 6, by receipt of the received-signal 8. When the velocity of the transmitted-signal 4 and the received-signal 8 through the propagation medium is known, the time of flight may be used to determine the distance between the transducer 2 and the target object 6. The amplitude of the reflected signal 8 may be indicative of some of the properties of the object 6 (such as size and impedance mismatch with the bulk medium).

FIG. 2 schematically illustrates the situation where the transducer 2 is in the form of a common transducer 10, which is used for both transmission when driven by transmitter circuitry 12 and reception when generating signals for receiver circuitry 14. The transmitted-signal 4 is modulated in accordance with a coded signal under control of a controller 16. The modulation could take a wide variety of different forms, such as frequency modulation, phase modulation, amplitude modulation or combinations thereof. The controller 6 includes cross-correlation circuitry 18 which serves to cross-correlate the received-signal 8 with the transmitted-signal 4 in accordance with a correlation algorithm based upon the known modulation applied to the transmitted-signal 4 in order to identify a time displacement and amplitude changes between the transmitted-signal 4 and the received-signal 2. The time displacement of the cross-correlation maximum corresponds to the time of flight of the signal between the common transducer 10 and the target object 6.

FIG. 3A schematically illustrates in graph (a) transmission of a transmitted-signal comprised of a number of transmission periods separated by transmission pauses. The transmission pauses vary in their duration within a range of transmission pause duration. Each transmission period generates a transmitted-signal which propagates through the propagation medium at a wave velocity v until it is reflected by a reflecting object a distance x from the transmitter. A reflected signal is then returned to the transmitter by propagation in the opposite direction through the propagation medium at the wave velocity v. When the reflected signal arrives back at the receiver it is able to be received if the transmitted-signal is not being generated at that time. A reflected signal which is lost is indicated by a time period “a” and a reflected signal which is captured as a received-signal is indicated by “b”. As will be seen, the variation in the transmission pause duration results in a variation in which portions of a reflected signal are lost and which portions are captured.

The transmitted-signal may be subject to a modulation (e.g. a coded sequence or chirp) which extends over a time period referred to as the modulation duration (the modulation duration may be a repeat period of the modulation applied to the transmitted-signal). In the case of modulation using a coded sequence, the modulation duration, may be the duration of the coded sequence. In the case of a chirp signal, the modulation duration may be the duration of the chirp signal. The modulation duration is large relative to the duration of the transmission period and the duration of the transmission pauses is such that the modulation duration extends over two or more of the transmission periods. In the case of a coded sequence, this gives a long sequence permitting a higher signal to noise ratio dependent upon the sequence length to be achieved. The transmission periods may vary in duration in addition to the variation in transmission pause duration. Modulation varies a carrier and coding represents the information being placed onto the carrier so that the modulation duration is the overall period and the coding specifies how the information is placed on the carrier. Many different forms of coding could be used.

The lower portion of FIG. 3A illustrates the times at which the reflected signal is captured and relates these to the times at which the corresponding portion of the transmission period which led to that captured reflected signal were transmitted. The varying nature of the transmission pause duration varies the time displacement between transmission of a signal and capture of the reflected signal during a transmission pause. In this way, “blind spots” occurring due to transmission of the transmitted-signals are moved relative to the time of flight of the signals such that at least one of the transmission pauses includes a time corresponding to receipt of a received-signal for any given time of flight within a measured range of time of flight that is being targeted by the system.

FIG. 3B illustrates in the upper portion the captured reflected signals plotted against the time since transmission of their respective originating portions of the transmitted-signal. As will be seen, these time differences vary as a consequence of the variation in the duration of the transmission pauses with the result that over time a wide range of possible times of flight are able to give rise to a reflected signal which will be captured during a transmission pause.

The lower portion of FIG. 3B illustrates the cross correlation of the captured reflected signals (received-signals) with the transmitted-signal for various values of an intervening time of flight and shows a peak corresponding to reflection from the reflecting object. The action of the transmission pauses of variable length permits reflected signals from reflecting objects at close range to be received during the transmission pauses, even though the modulation duration of the transmitted-signal is greater than the time of flight to those reflecting objects. This permits, for example, longer coded sequences to be used to improve the signal-to-noise ratio, while not imposing too high a value of the minimum range to an object to be detected.

FIG. 4 schematically illustrates in the upper portion a transmitted code which may be used to control modulation of a transmitted-signal to thereby carry the code. The coded sequence may be a binary sequence. The binary digits may be represented in different ways within the transmitted-signal depending upon the type of modulation used, such as frequency modulation, amplitude modulation and/or phase modulation. Modulating a signal with a code facilitates cross-correlation between the transmitted-signal and the received-signal to identify a time of flight or other characteristics of the wave form, such as amplitude and/or phase. Multiple signals may be transmitted and received using different coded sequences which may be orthogonal, pseudo-orthogonal or substantially orthogonal coded sequences to permit multiple independent channels for measuring different signal paths.

The lower portion of FIG. 4 schematically illustrates chirp modulation in which a transmitted-signal has a periodically varying frequency with time. Cross correlation between a transmitted-signal and a received-signal permits portions of the signal having the same frequency to be identified as a correlation maximum with the receipt of such a reflected signal then being used, for example, to identify the time of flight. As illustrated in FIG. 4, the transmission period duration may be a small portion of the time period over which the chirp signal varies its frequency during one cycle such that the modulation duration of the chirp signal extends over two or more transmission periods.

FIG. 5 schematically illustrates further example modulation schemes such as binary phase shift keying, frequency modulation and chirp. The figure also shows in its lower portion that the transmission periods do not need to be the same length, hence one and two symbol transmission.

FIG. 6 schematically illustrates an example embodiment using a selectable modulation scheme. The signal to be transmitted is generated in a transmitted-signal generation in dependence upon signals controlling a modulation scheme to be used, the code to be transmitted and the pause durations to be applied (e.g. coded or random). The formed signal is supplied to a transmitting transducer Tx. After reflection within the propagation medium the received-signal is received at the receiving transducer Rx. The received-signal is then cross-correlated with the signal transmitted in order to determine parameters such as the time-of-flight, amplitude and/or phase characteristics of the received-signal to be represented as the result.

FIG. 7 schematically illustrates how the transmission pause duration may be varied within a permitted range of transmitted pause duration. In the example illustrated, it is desired to have a uniform distribution of pause duration within the permitted range of transmission pause duration and this may be achieved by providing a random duration within the bounds of a minimum transmission pause duration and a maximum transmission pause duration.

FIG. 8 schematically illustrates the use of a one-dimensional array of common transducers each transmitting a transmitted-signal modulated with its own code sequence that is orthogonal to the other code sequences used. In the example illustrated, the transmitted-signals emanating from the uppermost transducer may be received during transmission pauses at any of the multiple transducers within the array. Reception of these reflected signals corresponds to reflection from an image point at a different distance along a plane (such as, for example, provided by a solid wall) illustrated as a reflective surface in FIG. 6.

FIG. 9 schematically illustrates a two dimensional array of transducers. In this case the N by N array uses N² orthogonal coded sequences and provides a large number of independent channels for detecting reflected signals. Other transducer array geometries may also be used.

FIG. 10 schematically illustrates the techniques described above becomes particularly attractive in combination with simple 1-bit signal acquisition hardware. 1-bit quantisation in combination with averaging enables high fidelity signal acquisition of ultrasonic signals that have a low SNR. However, the averaging process takes very long as it requires signal reverberation to have died down in between signal captures. The use of coded excitation sequences with gaps as is described herein removes that requirement and therefore enables rapid firing of the sequence and intermittent reception of the signal. The overall acquisition time is accordingly reduced. Furthermore, there may be a reduction in the complexity of the signal acquisition hardware (as no A/D converter is required) resulting in hardware that is more cost effective and smaller.

The sample frequency of the analog channels used may be equal to or less than the digital bus frequency of the digital sampling circuitry. In some example embodiments the analog signal may be directly connected to the digital bus. In other example embodiments a comparator may be provided to receive the analog signal and compare this with a predetermined value and generate a digital output signal supplied to the digital bus. In some example embodiments a digital latch may receive the signal output from the comparator and supply a latched signal to the digital bus.

### APPENDIX A

Many ultrasound applications produce signals which are weak and potentially fall below the noise level (basically electrical noise) at the receiver. However, after quantisation, the signal-to-noise ratio (SNR) is increased by ensemble averaging and filtering or pulse-compression techniques. This is possible because the excitation signals are recurrent. Some examples of applications where received signals are below the noise threshold can be found in [1] for electro-magnetic acoustic transducers, [2] for piezoelectric paints, [3] for photo-acoustic imaging, [4-6] for air-coupled ultrasound, and [7, 8] for guided ultrasonic waves.

In those cases the information has been shown to be recovered using quantisation levels which are not much bigger than the signal itself [3, 8-12]—the explanation of how this is possible was attributed to the effect of dithering [13-15]. Of particular interest is the work by [11], where it was reported that the information can be recovered using binary (one-bit) quantisation only. The same result was reported by [16] (a decade before) where binary quantisation was employed with time-reversal techniques and pulse-compression without degrading the spatial or temporal resolution of an array of sensors.

These findings have an important implication in the acquisition of signals embedded in noise since no analog-to-digital converter (ADC) is then required. Standard ADCs could be replaced by a comparator and a binary latch, and in some cases the analog channel could even be directly connected to the digital input. Without an ADC, the acquisition system becomes faster, more compact and energy efficient. All this is especially attractive for applications that require arrays with many channels and high sampling rates, where the sampling rate can be as high as the system clock, see FIG. 11; the maximum sampling rate of standard ADCs is usually less than the system clock.

The binary quantisation of noisy signals has been investigated extensively in the past years, mainly in the field of wireless sensor networks (WSN) [17-19], where the motivation was also limited power and bandwidth of the acquisition and data transmission systems. It is necessary to emphasise that binary quantisation is actually employed to later estimate a parameter of interest, in this case the signal embedded in noise, and not to necessarily reconstruct the exact sampled signal—see [20] for a discussion on this.

One of the main findings has been that when the signals are below the noise threshold the difference between binary quantisation and no quantisation at all, i.e. using infinite bits ADC, is roughly only 2 dB [16, 17], and that this difference increases as the SNR of the signal to be quantised increases [17, 18]. Further work has also been conducted to select the optimum threshold for the binary comparator [18, 19, 21].

For signals with greater SNR, i.e. above the noise threshold, the work has been focused on incorporating some control input before quantisation or adding extra quantisation levels [22]. However, this approach introduces extra complexity in the acquisition system that the authors wish to avoid in this paper, since their main goal is to investigate the conditions under which a simple system, as described in FIG. 11, can be employed for ultrasonic applications.

The input SNR range where binary quantisation is of practical interest has not yet been clearly defined. The following reviews the theory of binary quantisation from previous work (mainly that related to WSNs) and then investigates the input SNR range of practical interest for ultrasound applications.

This review is organised as follows: first, the theory related to binary quantisation from previous work is presented, then the maximum input SNRs that can be employed are investigated theoretically. Following this, some numerical simulations are carried out to corroborate the theoretical results. Experiments with binary-quantised ultrasound signals are presented and finally conclusions are drawn.

### Binary Quantisation and Averaging

The theory behind binary quantisation has been reported in [17, 18]. However, in this section it is reviewed again in a way that highlights how the different sources of error affect the results. The main sources of error are: a) the error introduced by binary quantisation itself and b) the error caused when only a limited number of quantised samples or repetitions are added (averaged).

Transfer Function of the Binary Quantiser after Averaging

Consider the stochastic signal

X(t)=s(t)+Y(t), (1)

where Y (t) is a random process whose repetitions are independent and identically distributed (i.i.d.) and s (t) is a deterministic signal invariant to each repetition of X (t), i.e. s (t) is said to be recurrent. FIG. 12 shows X and s and the input of the quantiser.

The output of the binary quantiser Q (t) can take the following values

$$q ( t ) = \{ \begin{matrix}1 & x ( t ) > 0 \\ - 1 & x ( t ) \leq 0\end{matrix} . \qquad ( 2 )$$

And hence the expected value of Q (t) is

E[Q(t)]=F̅_{X(t)}(0)−F_{X(t)}(0), (3)

where Fx (x) is the cumulative distribution function (CDF) of X and F̅ₓ=1−Fₓ. Fₓ is equal to the CDF of Y offset by s. Then, if Y is assumed to be normally distributed,

$$E [ Q ( t ) ] = 1 - 2 F [ - \frac{s ( t )}{{σ}_{y}} ] , \qquad ( 4 )$$

where F is the CDF of the standard normal distribution (mean μ=0 and standard deviation σ=1) and σ_{y} is the standard deviation ⋅ of Y. Note that Y acts as a noisy carrier for the signal s, which is the foundation of dithering. Equation (4) can be understood intuitively based on FIG. 13a-b, where F is plotted (FIG. 13a) together with several repetitions of X for a given t₀ and s (t₀)=1 (FIG. 13b). If the number of repetitions at either side of a certain level and their distribution are known, then the mean value of the distribution can be estimated relative to its standard deviation, σ_{y}.⋅

After adding N repetitions of Q, the resulting signal is equivalent to N·E[Q (t)] plus an error signal

$${e}_{comp} ( t ) = {\sum }_{n = 1}^{N} {q}_{n} ( t ) - N \cdot E [ Q ( t ) ] . \qquad ( 5 )$$

This process is summarised in FIG. 12. The variance of e_{comp} is discussed in the next section.

Since the result of adding binary signals has to be an integer, the following rounding operation on N·E[Q (t)] has to be introduced

C_{N}(t)=└N·E[Q(t)]+0.5┘, (6)

where └⋅┘ H is the floor operator nearest integer not greater than N·E[Q(t)]. Now C_{N}∈Z with C_{N}=[−N, N], so it can only take 2N+1 integer values. This introduces a round-off error (see FIG. 12)

eₛₐₜ(t)=C_{N}(t)−N·E[Q(t)]. (7)

It will later be shown that the effect of eₛₐₜ (t) on the quantisation output is only significant when saturation occurs, i.e. C_{N}={−N, N}.

Due to F being a non-linear function, equation (4) describes a type of non-linear quantisation similar to that of μ- and A-law companders [23], where a “compression function”—equation (4)—is uniformly quantised by 2N+1 levels. To compensate for the non-linearity introduced by the “compression function”, an “expansion function” is required, which is basically the inverse of equation (4). Note, however, that the floor operation in equation (6) cannot be reversed; however, this error is not the predominant one as far as saturation does not occur.

After the expansion operation, the expected value of the quantised signal is

$${s}_{Q , N} ( t ) = - {F}^{- 1} [ \frac{N - {C}_{N} ( t )}{2 N} ] , \qquad ( 8 )$$

where F⁻¹ is the inverse of F. It will be later shown that if −N<C_{N} (t)<N, i.e. saturation does not occur, then eₛₐₜ is negligible with respect to e_{comp} and hence the input and output signals of the quantiser are proportional on average. In other words, the quantiser can be regarded as a linear system that introduces a given error e_{comp},

s(t)∝E[s_{Q,N}(t)], −N<C_{N}(t)<N. (9)

Conversely, as eₛₐₜ becomes predominant, the linearity of the system starts to break down.

### Quantisation Errors and SNR

Given that Y is an i.i.d. process, the variance of Q (t) after adding N repetitions is

$${σ}_{Q , N}^{2} = 4 N \cdot F ( \frac{s}{{σ}_{y}} ) \overline{F} ( \frac{s}{{σ}_{y}} ) , \qquad ( 10 )$$

where F̅=1−F; note that t has been dropped to simplify the notation. This is also the variance of e_{comp}, which can be assumed—without loss of generality—normally distributed with mean μ=0.

Now, suppose that eₛₐₜ is negligible with respect to e_{comp} for −N<C_{N} (t)<N, then the standard deviation of s_{Q} due to e_{comp} can be approximated as

$${σ}_{{s}_{Q} , N} \approx \{ \begin{matrix}{s}_{Q , N} + {F}^{- 1} [ \frac{N - {C}_{N} - {σ}_{Q , N}}{2 N} ] & N > {C}_{N} \geq 0 \\ {s}_{Q , N} - {F}^{- 1} [ \frac{N - {C}_{N} + {σ}_{Q , N}}{2 N} ] & - N < {C}_{N} < 0\end{matrix} . \qquad ( 11 )$$

In [18,19] a close-form Chernoff bound is used to estimate the variance; however, the authors found that the approximation in (11) produced accurate results for all the SNR input values that were simulated.

Additionally, the signal-to-noise ratio (SNR) at the output of the binary quantiser can be approximated as

$$SNR \approx \frac{E [ {s}_{Q , N} ( t ) ]}{{σ}_{{s}_{Q , N}}} - N < {C}_{N} < N . \qquad ( 12 )$$

It is interesting to investigate the output SNR when

$$\frac{s}{{σ}_{y}} ≪ 1 ,$$

i.e. the signal is below the noise threshold. In that case F can be regarded as a linear function of s (see FIG. 13a). Therefore, the SNR at the output of the quantiser is the same before and after the expansion operation. Then, if the floor operation in equation (6) is omitted, the following approximation for the SNR is obtained, see [16, 17],

$$\frac{{s}_{Q , N}}{{σ}_{{s}_{Q , N}}} {\vert}_{\frac{s}{{σ}_{y}} ≪ 1} \approx \frac{N \cdot E [ Q ]}{{σ}_{Q , N}} \approx \frac{s}{{σ}_{y}} \sqrt{\frac{2}{π} N} \qquad ( 13 )$$

Hence for

$$\frac{s}{{σ}_{y}} ≪ 1 ,$$

the resulting SNR after binary quantisation and N repetitions is just roughly 0.8 times (2 dB) smaller than without any quantisation at all, i.e. an infinite bits ADC that produces a

$$SNR = \frac{s}{{σ}_{y}} \sqrt{N}$$

Note that the

$${F}^{′} ( 0 ) = \sqrt{\frac{2}{π}}$$

Where F′ is the derivative of F.

### Limits of Binary Quantisation

In general, it will be shown experimentally that the error e_{comp} is predominant over eₛₐₜ when C_{N}≠{−N,N}. In that case the error introduced by the floor operation is infinite because S_{Q}={−∞, ∞} even when −∞<s<∞. Note that if −N<C_{N}<N, then

$$- {F}^{- 1} ( 1 - \frac{1}{4 N} ) > {s}_{Q} > - {F}^{- 1} ( \frac{1}{4 N} ) \qquad ( 14 )$$

Thus, these upper and lower bounds define the quantiser range where the quantisation error takes finite values. To prevent S_{Q} from being infinite in the event C_{N}={−N, N}, S_{Q} can be truncated to the closer of these bounds, in which case a significant saturation error eₛₐₜ is introduced.

The impact of eₛₐₜ in the results is also given by the number of times that C_{N}={−N, N} occurs in N repetitions. To predict when eₛₐₜ has a significant impact on the results, it is useful to find the probability of reaching the condition C_{N}=N for a given

$$\frac{s ( t )}{{σ}_{y}} \\ {p}_{N} = {F [ - \frac{s ( t )}{{σ}_{y}} ]}^{N} . \qquad ( 15 )$$

Moreover, to numerically investigate the standard deviation at the output of the quantiser for N added repetitions (σ_{sQ,N}), M sets with N repetitions each have to be assessed. The probability of having C_{N}=N L times in M repetitions follows the binomial distribution

$${p}_{L} = ( \begin{matrix}M \\ L\end{matrix} ) {{p}_{N}^{L} ( 1 - {p}_{N} )}^{M - L} \qquad ( 16 )$$

while the probability of having C_{N}=N more than L times is

$${p}_{L , cum} = {\sum }_{k = L}^{M} ( \begin{matrix}M \\ L\end{matrix} ) {{p}_{N}^{k} ( 1 - {p}_{N} )}^{M - k} . \qquad ( 17 )$$

Equation (17) can be used to predict, for example, the value of s for which CN=N occurs more than 10% of the time—i.e. L=0.1M—with a probability of 0.9. This may be used to indicate when eₛₐₜ has a significant impact on the results.

It is equally useful to know the probability of C_{N}=N occurring at least once in M repetitions

p_{1,cum}=1−(1−p_{N})^{M}, (18)

which may indicate when eₛₐₜ starts becoming predominant over e_{comp}.

### Numerical Simulations

A set of 10² and 10⁴ samples were normally distributed with σ=1 to obtain the random process Y (t). The mean of the distribution was varied from −5 to 15 dB in intervals of 1 dB to simulate s (t). Each sample was binary quantised, then added (averaged) and expanded using equation (8); this process is summarised in FIG. 12. Hereinafter, for the sake of brevity, these three operations will be referred to as quantisation. The maximum/minimum value of each repetition after the expansion operation was limited to the upper/lower bound in equation (14), so that infinite results were avoided. Each step was repeated 10⁴ times to investigate the expected values and the SNRs at the output of the quantiser.

### Expected Value at the Output of the Quantiser

FIG. 14 shows the expected value at the output of the quantiser for a given input signal. The input is the ratio between the mean and the standard deviation of the set of samples at the input; this ratio is the distribution mean s (t) since the standard deviation σ=1. The circle markers correspond to the simulated sets of (a) 10² and (b) 10⁴ added samples. The dot markers represent the theoretical expected values according to equation (8). The continuous line represents the ideal acquisition process, where there is no saturation or rounding error eₛₐₜ. The vertical dotted line (labelled Sat.>1) indicates the occurrence of saturation at least once with a probability of 10⁴; this is basically the value of s for which equation (18) yields 10⁴. The other vertical dotted line (labelled Sat.>10%) indicates the occurrence of saturation 10% of the time with a probability of 0.9; this is the value of s for which equation (17) gives 0.9 with L=0.1M.

In general there is good agreement between the theory presented above and the simulations. It can be observed that equation (17) can be used to predict the value of the input mean where the linearity of the system changes, i.e it becomes non-linear. Moreover, when the maximum/minimum value of each repetition is truncated using equation (14) so that the result is not infinite, the input range that produces a linear output is extended from the first occurrence of saturation (marked by Sat.>1) to roughly where saturation occurs 10% of the time. This increase is approximately 5 and 1 dB for the sets of 10² and 10⁴ samples respectively; note that truncation has a greater impact on the set with fewer samples. Overall, the greater the number of samples (equivalent in practice to the number of averages) in a set, the greater the bounds in equation (14) and therefore the greater the input range of the quantiser.

### Output SNR

FIG. 15 shows the SNR before and after quantisation. The SNR of each simulation is computed as the ratio of the mean and the standard deviation of the set; these are marked as circles. The dot markers represent the outputs of equation (12). The continuous line is the theoretical result assuming there is no saturation or rounding error. The dashed line represents the resulting SNR without quantisation, i.e. the standard deviation of the sum of all of the samples in a set. The vertical dotted lines, labelled Sat.>1 and Sat.>10% are the same as in the previous figure.

Again, the theory presented above and the simulations match well before saturation takes place (i.e. below the input SNR market by vertical dotted line labelled Sat.>1). This then implies that e_{comp}, see equation (5), is the predominant source of noise for this input SNR range. Note that for an input SNR below −5 dB the difference between binary quantisation and no quantisation at all (dashed line) is roughly 2 dB as predicted by equation (13). In general, the resulting SNR after binary quantisation is always smaller than the SNR without any quantisation at all. The resulting SNR produced by any other type of quantisation, e.g 2- or 12-bit quantisation, should lie between these two cases.

For input SNR values between the dotted lines Sat.>1 and Sat.>10%, saturation causes the output SNR to be overestimated by no more than 2 dB. Note that the distance between the dotted lines shortens as the number of added samples in the set increases. Results that correspond to an input SNR beyond the line Sat.>10% should be ignored as errors due to saturation are significant and the information is lost.

FIG. 16 shows the outputs of equation (12) for an input SNR between −5 and 15 dB using 10⁴ sets of 10², 10³ and 10⁴ repetitions. It is clearly visible that the curves are vertically offset and that the output SNR increases as a function of N as long as the input SNR remains below ˜8-12 dB. It can be noted that the maximum output SNR (SNRₘₐₓ) occurs when the input SNR is roughly 4 dB and that for each number of samples, the corresponding SNRₘₐₓ is slightly smaller than the number of samples (in a decibel scale 10 log 10 N).

In FIG. 17 the difference 10 log₁₀ N−SNRₘₐₓ is plotted with a dashed-dotted curve for 10² to 10⁶ repetitions. From the curve the following expression can be used as a good estimate of SNRₘₐₓ when N>10³

SNRₘₐₓ≈10 log₁₀ N−2 N>10³ (19)

The input SNR that yields SNRₘₐₓ is also shown in FIG. 17 (dashed-dotted curve); this confirms the previous observation that SNRₘₐₓ occurs when the input SNR is roughly 4 dB.

Finally, the dotted and continuous curves in FIG. 17 indicate the input SNR where saturation occurs 10% of the time with a probability of 0.9 sets of 10 and 10⁴ samples respectively. Note that the size of the set has a minor effect on the results. These curves are a good approximation of the maximum input SNR that produces a non-distorted output of the quantiser. For example, when N=10³, the maximum input SNR that produces a non-distorted output is approximately 9 dB; the maximum input SNR only increases by roughly 4 dB when N=10⁶.

In the interval N=[10³, 10⁶] the maximum input SNR (SNR_{max,in}) can be approximated as

$${SNR}_{max , in} \approx \frac{4}{3} {log}_{10} N + 4 , N = [ {10}^{3} , {10}^{6} ] . \qquad ( 20 )$$

Overall, a minimum bound for the input SNR range (difference between maximum and minimum input SNR in decibels), which can also be understood as the input signal dynamic range, can be approximated as

D>10 log₁₀N−SNRₘᵢₙ+2, N=[10³,10⁶], (21)

where SNRₘᵢₙ is the minimum tolerable SNR after quantisation and averaging (defined for each application beforehand). As an example, if SNRₘᵢₙ=20 dB and it is desired D>8 dB, then N>100. The dynamic range D is therefore tuneable by adjusting the number of averages N. This means that the dynamic range can be increased at the cost of decreased measurement speed in order to suit the requirements of different applications. In general, binary quantisation offers a lower input SNR range compared to standard ADCs. This is because ADCs can be thought of as a superposition of offset binary quantisers. However, once the signals are embedded in noise, the advantage of using a standard ADC is only a 2 dB increase in SNR. It is important to recall that filtering increases the SNR by removing the noise outside the frequency band of interest. Therefore, the effective input SNR range is also increased by filtering.

### Results

Ultrasound signals were recorded before and after a comparator as shown in FIG. 18 Two transducers (Panametric V151, Olympus, Mass. 02453, USA) were used, one on each side of a 300 mm-thick aluminium block. The transmit transducer was connected to a driver, which triggered an oscilloscope (LeCroy WaveRunner 44Xi). The signal from the receive transducer was amplified and filtered, after which the signal splits into two; one cable connecting directly to the scope and the other entering the scope via the comparator. The scope has 8-bit resolution and 2 mV minimum sensitivity. The comparator was built using a fast amplifier (LMH6629, Texas Instruments, Texas, US) without feedback. The driver, amplifier and filter are independent units of a pulse-echo system WaveMaker-Duet-custom made for the NDE group of Imperial College London.

The driver was set to transmit a 5-cycle tone-burst with a Hann tapering and a central frequency of 200 kHz. The amplifier gain was set to 60 dB and the response of the band-pass filter in the WaveMaker-Duet system was assumed to encompass the tone-burst frequency band. The comparator reference level was calibrated with a potentiometer such that the mean value of the resulting signal at the output was in the middle of the comparator output range; this was to maximise the dynamic input range.

In FIG. 19 the black curve corresponds to the section of the signal which contains noise at the input of the comparator, whereas the grey curve corresponds to the output. The output of the comparator indicates when the noise is above or below 0 mV in the figure. The shortest time interval between the comparator transitions, i.e. the minimum pulse width, is determined by the comparator and noise bandwidth. The minimum pulse width can be considered equivalent to the effective sampling rate of the signal. Its width was found to be roughly below 0.5 μs, so the effective sampling frequency is greater than 2 MHz, which is ten times greater than the tone-burst central frequency.

The driver excitation intensity was set such that the receive echoes were below the noise threshold. The receive signals were averaged 4000 times; the results are shown in FIG. 20a-b. As expected, there is only a small difference between the signals at the input and output of the comparator. This confirms that provided the input signal is below the noise threshold, it is possible to recover the information after the signal has been binary quantised. It should be noted, however, that in the case of the binary quantised signal, the positive side of the cycles was attenuated. This could have been caused by problems in the design of the comparator; for example, the quantiser taking longer to re-cover from saturation in the positive cycle, not swinging symmetrically between positive and negative cycles, or any hysteresis effect at its input.

### Conclusions

In this paper the theory of binary quantisation of recurrent signals embedded in noise was reviewed in detail. Binary quantisation and averaging can be under-stood as a non-linear acquisition process similar to standard companding techniques where an expansion function is required to compensate for non-linearities introduced in the process.

The input SNR where binary quantisation is of practical value for ultrasound applications was investigated, and it was found that in most cases binary quantisation can only be employed when the input SNR is below 8 dB. Hence, the input SNR of the binary quantiser is significantly smaller compared to standard ADCs, which can be understood as a set of offset binary quantisers. Moreover, the maximum SNR after binary quantisation and averaging can be estimated as 10 log 10 N−2; therefore, at least a few hundred of repetitions (averages) are required to produce a SNR at the output greater than 20 dB.

However, the fact that there is only a 2 dB difference between binary quantisation and no quantisation at all when the signals are below the noise threshold has an important implication in the quantisation of signals embedded in noise. Standard ADCs can be replaced by a comparator and a binary latch, and in some cases the analog channel could even be directly connected to the digital input. All this is especially attractive for applications that require arrays with many channels and high sampling rates, where the sampling rate could be as high as the system clock. In general the electronics can be more compact, faster and consume less energy.

### REFERENCES

[1] K. Ho, T. Gan, D. Billson, and D. Hutchins, “Application of pulse compression signal processing techniques to electromagnetic acoustic transducers for noncontact thickness measurements and imaging,” Review of scientific instruments, vol. 76, no. 5, p. 054902, 2005.
[2] I. Payo and J. Hale, “Sensitivity analysis of piezoelectric paint sensors made up of pzt ceramic powder and water-based acrylic polymer,” Sensors and Actuators A: Physical, vol. 168, no. 1, pp. 77-89, 2011.
[3] M. Mienkina, C.-S. Friedrich, N. Gerhardt, W. Wilkening, M. Hofmann, and G. Schmitz, “Experimental evaluation of photoacoustic coded excitation using unipolar golay codes,” Ultrasonics, Ferroelectrics and Frequency Control, IEEE Transactions on, vol. 57, no. 7, pp. 1583-1593, 2010.
[4] T. Gan, D. Hutchins, D. Billson, and D. Schindel, “The use of broadband acoustic transducers and pulse-compression techniques for air-coupled ultrasonic imaging,” Ultrasonics, vol. 39, no. 3, pp. 181-194, 2001.
[5] M. Ricci, L. Senni, and P. Burrascano, “Exploiting pseudorandom sequences to enhance noise immunity for air-coupled ultrasonic nondestructive testing,” Instrumentation and Measurement, IEEE Transactions on, vol. 61, no. 11, pp. 2905-2915, 2012.
[6] R. J. Przybyla, S. E. Shelton, A. Guedes, I. Izyumin, M. H. Kline, D. Horsley, B. E. Boser, et al., “In-air rangefinding with an aln piezoelectric micromachined ultrasound transducer,” Sensors Journal, IEEE, vol. 11, no. 11, pp. 2690-2697, 2011.
[7] J. E. Michaels, S. J. Lee, A. J. Croxford, and P. D. Wilcox, “Chirp excitation of ultrasonic guided waves,” Ultrasonics, vol. 53, no. 1, pp. 265-270, 2013.
[8] X. Song, D. Ta, and W. Wang, “A base-sequence-modulated golay code improves the excitation and measurement of ultrasonic guided waves in long bones,” Ultrasonics, Ferroelectrics, and Frequency Control, IEEE Transactions on, vol. 59, no. 11, 2012.
[9] M. Garcia-Rodriguez, Y. Yanez, M. Garcia-Hernandez, J. Salazar, A. Turo, and J. Chavez, “Application of golay codes to improve the dynamic range in ultrasonic lamb waves air-coupled systems,” NDT & E International, vol. 43, no. 8, pp. 677-686, 2010.
[10] R. Challis and V. Ivchenko, “Sub-threshold sampling in a correlation-based ultrasonic spectrometer,” Measurement Science and Technology, vol. 22, no. 2, p. 025902, 2011.
[11] M. Ricci, L. Senni, and P. Burrascano, “Exploiting pseudorandom sequences to enhance noise immunity for air-coupled ultrasonic nondestructive testing,” Instrumentation and Measurement, IEEE Transactions on, vol. 61, no. 11, pp. 2905-2915, 2012.
[12] R. Challis, V. Ivchenko, and R. Al-Lashi, “Ultrasonic attenuation measurements at very high snr: Correlation, information theory and performance,” in Journal of Physics: Conference Series, vol. 457, p. 012004, IOP Publishing, 2013.
[13] L. R. Carley, “An oversampling analog-to-digital converter topology for high-resolution signal acquisition systems,” Circuits and Systems, IEEE Transactions on, vol. 34, no. 1, pp. 83-90, 1987.
[14] P. Carbone and D. Petri, “Effect of additive dither on the resolution of ideal quantizers,” Instrumentation and Measurement, IEEE Transactions on, vol. 43, no. 3, pp. 389-396, 1994.
[15] R. M. Gray and T. G. Stockham Jr, “Dithered quantizers,” Information Theory, IEEE Transactions on, vol. 39, no. 3, pp. 805-812, 1993.
[16] A. Derode, A. Tourin, and M. Fink, “Ultrasonic pulse compression with one-bit time reversal through multiple scattering,” Journal of applied physics, vol. 85, no. 9, pp. 6343-6352, 1999.
[17] H. C. Papadopoulos, G. W. Women, and A. V. Oppenheim, “Sequential signal encoding from noisy measurements using quantizers with dynamic bias control,” Information Theory, IEEE Transactions on, vol. 47, no. 3, pp. 978-1002, 2001.
[18] A. Ribeiro and G. B. Giannakis, “Bandwidth-constrained distributed estimation for wireless sensor networks-part i: Gaussian case,” Signal Processing, IEEE Transactions on, vol. 54, no. 3, pp. 1131-1143, 2006.
[19] J. Fang and H. Li, “Distributed adaptive quantization for wireless sensor networks: From delta modulation to maximum likelihood,” Signal Processing, IEEE Transactions on, vol. 56, no. 10, pp. 5246-5257, 2008.
[20] R. M. Gray, “Quantization in task-driven sensing and distributed processing,” in Acoustics, Speech and Signal Processing, 2006. ICASSP 2006 Proceedings. 2006 IEEE International Conference on, vol. 5, pp. V-V, IEEE, 2006.
[21] U. S. Kamilov, A. Bourquard, A. Amini, and M. Unser, “One-bit measurements with adaptive thresholds,” Signal Processing Letters, IEEE, vol. 19, no. 10, pp. 607-610, 2012.
[22] E. J. Msechu, S. Roumeliotis, A. Ribeiro, G. B. Giannakis, et al., “De-centralized quantized kalman filtering with scalable communication cost,” Signal Processing, IEEE Transactions on, vol. 56, no. 8, pp. 3727-3741, 2008.
[23] B. A. Carlson, “Introduction to communication systems,” 2001.

### APPENDIX B

Pulse-compression is known to increase the signal to noise ratio (SNR) and resolution in radar [1,2], sonar [3,4], medical [5-11] and industrial ultrasound [12-17]; initial applications can be traced back to the mid 1940s [18]. It consists in transmitting a modulated and/or coded excitation, which is then correlated with the received signal such that received echoes become shorter in duration and of higher intensity, thereby increasing the system resolution and SNR. Pulse-compression is a faster alternative to averaging; averaging is lengthy because a wait time is required between consecutive excitations during which the energy in the medium that is inspected dies out and therefore does not cause interference between excitations.

The two main approaches to pulse-compression are chirp signals and coded excitation (or sequences). Chirp signals are obtained by frequency-modulating the excitation; the increase in SNR and resolution depends on the chirp length and bandwidth [11]. Coded sequences operate in a slightly different way, a common technique is to codify the polarity of concatenated bursts according to a binary sequence, i.e. a sequence composed of 1s and 0s or +1s and −1s [19]. In any case a good approximation to the single initial burst is obtained when correlating the received signal with the transmitted sequence, hence the term compression.

Provided that the properties of the medium that is being inspected do not change (e.g. the speed of sound due to temperature variation or the location of the scatterers), the coded sequence length can be increased indefinitely to enhance the SNR without affecting the system bandwidth and resolution. However, this is not the case for chirp signals. In the applications that initially motivated this paper, namely low-power excitation of electromagnetic-acoustic transducers [12], piezoelectric paints [20], photo-acoustic imaging [13], air-coupled ultrasound [14, 17, 19, 21], and guided ultrasonic waves [6, 16], an SNR increase of more than 30 dB is required and the system constraints on bandwidth are predominant over the excitation length. This study therefore focuses on pulse-compression using coded sequences and especially binary coded sequences because they are simpler to implement than non-binary ones. It is worth mentioning that coded sequences with good autocorrelation properties also find many applications in communication system such CDMA, MIMO, GPS among others and channel estimation [22-32] as well as in compressed sensing [33].

Overall, the performance of a coded sequence relies on its autocorrelation properties. Ideally, its autocorrelation should be a delta function but this cannot be achieved with a single sequence. The quest for “good” sequences started around the middle of the last century [34-37] and still continues today [27,38,39]; see [40-42] for a comprehensive review of the different sequences. Among the key binary sequences known so far are those named after Barker [43, 44], and Legendre [45], as well as maximum length register sequences [46]. This list is not exhaustive and other sequences can be found in the literature [41], though some may be considered either as special cases or family members of those previously mentioned.

One of the most elegant solutions to the imperfection of the autocorrelation properties of a single sequence can be found in [34], whereby paired complementary sequences produce a perfect delta function when their corresponding autocorrelations are added together; this was later extended to orthogonal complementary sets of sequences in [35]. Another solution is to use sequences that achieve zero or very low autocorrelation values only in certain intervals of interest [23, 31, 32, 47, 48]. In general, there has been a tremendous interest in improving the autocorrelation properties of sequences, mainly by means of optimisation strategies, for example [24,25,27,29-32], and also in efficient ways of processing and obtaining them [22, 23, 28].

The fact that good or perfect autocorrelation can be (partially) achieved is highly relevant; however, there are certain scenarios where the SNR at the input of the amplifier is low [6,12-14,16,19-21], and in these cases good autocorrelation properties are not essential. Indeed, in this paper it is shown that when the SNR is low (e.g. the signal amplitude is comparable to or below the noise level) the choice of the sequence is relatively unimportant and a simple random sequence that has a uniform distribution of +1s and −1s will suffice in most cases.

The goal in those scenarios is to transmit the longest sequence possible to achieve the highest SNR increase, but another problem then emerges: in a pulse-echo system (like those used in radar, sonar, medical and industrial ultrasound), the distance between the closest reflector and the transmit/receive source limits the maximum length of the transmitted sequences. This problem is even more critical when reflectors are located both very close to and very far from the transmit/receive source because then even averaging, to increase the SNR, is not practical. This is due to the need for a very long wait time to avoid the echoes from the farthest reflector causing interference.

FIG. 21a-c illustrates the limitations of averaging and conventional pulse-compression in specimens with close and far reflectors using a simple back-wall example that has strong reverberations. FIG. 21a shows the location of the transducer operating in pulse-echo and the back-wall. The received signals when using averaging are shown in FIG. 21b. It can be observed that after each excitation several echoes are received, which decay progressively. Note that when there is not enough separation between transmissions, interference occurs. In this particular example averaging would take a long time because a long separation is required between transmissions to avoid any interference.

FIG. 21c shows the received signals when transmitting a sequence. In this case the maximum length of the transmitted sequence is limited by the location of the back-wall. Note that if the duration of the transmitted sequence is such that the reflection from the back-wall is overlapped by the excitation, the information is lost because it is not possible to receive while transmitting.

In this paper the authors propose a solution to these problems by introducing blank gaps or intervals within a sequence in which reception can take place while the sequence is being transmitted, see FIG. 21d. Hence, the overall sequence length and SNR increase is independent of the location of the reflectors. The aim of this idea is to significantly increase the SNR without significantly degrading the overall duration of the measurement so that the pulse-echo system can still respond to fast changes in the medium that is being inspected.

The organisation of this paper is as follows: first the autocorrelation properties of standard sequences and the corresponding SNR increase are discussed in Sec. 2. The properties and construction of coded sequences with reception gaps are introduced in Sec. 3. In Sec. 4 experimental results are presented. After discussing the results, conclusions are drawn.

### Background on Coded Excitation

### Merit Factor

For coded excitation the key sequence property is its periodic autocorrelation. Let X be a sequence of N elements, where each element x takes values +1 or −1. The aperiodic autocorrelation of this sequence at shift k is

$${c}_{k} = {\sum }_{j = 0}^{N - k - 1} {x}_{j} {x}_{j + k} , k = 0 , … , N - 1. \qquad ( 1 )$$

Golay introduced the merit factor, F, of a sequence [49] to compare and measure its performance

$$F = \frac{{N}^{2}}{2 {\sum }_{k = 1}^{N - 1} {c}_{k}^{2}} . \qquad ( 2 )$$

The merit factor can be understood as measure of how similar the autocorrelation result is to a delta function; for the sake of simplicity it should be assumed that the sequence of cₖ elements has a zero mean. A random binary sequence with +1 s and −1 s has F≈1 on average for large N [49]; a Barker sequence of 13 elements, which is the longest known, has F≈44.08 [44, 45]; Golay sequences have F≈3, the added autocorrelations of the Golay complementary sequences have of course F=∞ (i.e. a delta); while Legendre sequences can achieve F≈6 [45].

Finding sequences with optimal merit factor for a given length by extensive search is computationally demanding; the best known cases from 60 to 200 elements are limited to F≈10 [41, 42]. For longer sequences it is expected that max {F}<6 since no sequence with higher merit factor has been found, though this remains a conjecture [42]. If this conjecture were to be proven, the pay-off of searching for the optimal sequences (F≈6) would only be an increase equivalent to 6 times the performance of the easy-to-obtain random sequence (F≈1), which represents an SNR increase of less than 8 dB.

### SNR Increase

When adding (averaging) N received signals from identical excitations, the resulting SNR is

SNR_{avg}=N·SNRᵢₙ, (3)

where the input SNR, SNRᵢₙ, is defined as

$${SNR}_{in} = \frac{{s}^{2}}{{σ}_{in}^{2}} , \qquad ( 4 )$$

where s² is the energy of the received signal (burst) and σᵢₙ² is the variance of the received noise, which has zero mean. In practice, e.g. in ultrasound systems, the received noise is mainly due to electrical noise of the receive amplifier; for simplicity this noise can be assumed to be additive white Gaussian noise.

When using coded excitation the cross-correlation of the received signal and the transmitted sequence introduces noise. Let the transmitted sequence be of length N with unit amplitude and let the received sequence take values +s and −s. Then the energy at shift k=0 after cross-correlation is (N·s)², while the sample variance of the noise introduced by the cross-correlation is σₛ², which can be defined as

$${σ}_{s}^{2} = \frac{2 {s}^{2}}{N - 1} {\sum }_{k = 1}^{N - 1} {c}_{k}^{2} \approx \frac{N \cdot {s}^{2}}{F} , \qquad ( 5 )$$

when N is large. The factor of 2 in equation (5) has been added to compensate for the tapering effect the correlation has on cₖ. This can be dropped when the tapering effect is negligible, e.g. when the correlation is either “unbiased” or two sequences of significantly different lengths are cross-correlated.

Now let Y be a sequence of independent and identically (normally) distributed (i.i.d.) elements yⱼ with zero mean and variance σ²; say this sequence represents the noise added at the receiver. The sample variance of the result of cross-correlating Y with the transmitted sequence can be approximated, if N is large, to

$${σ}_{Y}^{2} \approx E [ \frac{2}{N - 1} {\sum }_{k = 1}^{N - 1} {d}_{k}^{2} ] \qquad ( 6 )$$

where E[⋅] denotes expected value. Since each dₖ is i.i.d with zero mean

$$\begin{matrix}{σ}_{Y}^{2} \approx \frac{2}{N - 1} {\sum }_{k = 1}^{N - 1} E [ {d}_{k}^{2} ] , & ( 7 ) \\ {d}_{k} = {\sum }_{j = 0}^{N - k - 1} {y}_{j} {x}_{j + k} , k ∈ [ 1 , N - 1 ] . & ( 8 )\end{matrix}$$

Due to each yⱼ and xⱼ₊ₖ being also i.i.d. with zero mean,

$$E [ {d}_{k}^{2} ] = {\sum }_{j = 0}^{N - k - 1} E [ {y}_{j}^{2} ] E [ {x}_{j + k}^{2} ] = {σ}^{2} ( N - k ) , k ∈ [ 1 , N - 1 ] \qquad ( 9 )$$

### Hence,

σ_{Y}²≈Nσ², (10)

Finally, given that the noise introduced by the sequence is independent of the noise introduced by Y, the SNR of the aperiodic cross-correlation can be approximated, when N is large, as

$${SNR}_{s} = \frac{{( N \cdot s )}^{2}}{{σ}_{s}^{2} + {σ}_{Y}^{2}} \approx \frac{N}{\frac{1}{F} + \frac{1}{{SNR}_{in}}} . \qquad ( 11 )$$

There are two special cases of interest in equation (11)

$${SNR}_{s} \approx \{ \begin{matrix}N \cdot {SNR}_{in} & if F ≫ {SNR}_{in} \\ N \cdot F & if F ≪ {SNR}_{in}\end{matrix} . \qquad ( 12 )$$

If F>>SNRᵢₙ, the SNR increase due to coded excitation is that of averaging-see equation (3). Moreover, there is no benefit in using sequences with F>1 (i.e. other than random sequences, which achieve F≈1 when N is large)

to increase the SNR when SNRᵢₙ<<1. Note that even the complementary Golay sequences, which can perfectly cancel the sequence noise [34, 35], yield no advantage in this case.

Interestingly, many scenarios exist where either SNRᵢₙ˜1 or SNRᵢₙ<<1 and hence a significant number of averages or long sequences are required (commonly N>1000) to produce a satisfactory SNR, which often needs to be in the order of 30-50 dB. These scenarios are usually found in systems that rely on inefficient/poor transducers or constraints on the excitation power. For example, electromagnetic acoustic transducers [12], piezoelectric paints [20], photo-acoustic imaging [13], air-coupled ultrasound [14, 19, 21], and guided ultrasonic waves [6, 16].

Conversely, if F<<SNRᵢₙ, the SNRₛ is independent of SNRᵢₙ, and if SNRᵢₙ is high, it may happen that SNRᵢₙ>SNRₛ for a given N due to the noise introduced by the sequence during the cross-correlation operation. In these cases special attention should be paid to increasing the merit factor F and hence to the use of complementary Golay sequences and zero autocorrelation zone sequences [23,31,32,47,48]. The latter may produce (under certain conditions) the highest merit factors for a single sequence.

The sequence (or more specifically burst) modulation has been left aside in order to focus the attention on the sequences themselves. Nonetheless, modulation can also increase the SNR after correlation. For example, if a burst A has A elements aⱼ (after being time-sampled), then the energy of the cross-correlation at shift k=0 increases by Σⱼ₌₀^{A-1}aⱼ². Modulation may also act as a match filtering process, which further increases the SNR. Both burst length and apodization affect the resulting SNR but at the same time they also bear a strong relationship with the pulse-echo system resolution, so their optimal selection is not arbitrary.

Properties and Synthesis of Sequences with Receive Intervals

In a pulse-echo system the maximum length of a conventional coded excitation (or sequence) is limited by the distance between the closest reflector and the transmit/receive source, see FIG. 21. In order to transmit longer sequences, gaps—where reception can take place—can be introduced in the sequences. In this section the rationale behind this approach is explained and the optimal gap distribution within a given sequence is discussed.

Synthesis of Sequences with Receive Intervals

It is desirable to create a ternary random sequence Z that takes values +1, −1, and 0. When this sequence is transmitted, reception can take place during the transmission of the zeroes, hence the name reception gap or receive interval. First, the optimal distribution of the zeroes is addressed, then the changes in the SNR as a result of introducing the zeroes are investigated.

Let X be a binary sequence of length L that takes values +1 and −1 and let G be another binary sequence also of length L that takes values +1 and 0. Sequence Z can be obtained as

Z=X·G=(x₀g₀,x₁g₁, . . . ,x_{L-1}g_{L-1}), (13)

where each xⱼ and gⱼ are i.i.d.

FIG. 22a-c) shows an example of the construction of Z. The sequence G (a) controls the location of the receive intervals (gⱼ=0) and transmit intervals (gⱼ=1), X (b) controls the polarity (±1) of the bursts during the transmit interval (gⱼ=1), while the actual transmitted sequence is Z (c). For simplicity, and without loss of generality, every transmit or receive intervals corresponding to a given gⱼ is considered to be of the same length.

Now let g̅ⱼ be the complement of gⱼ defined as

$${\overline{g}}_{j} = \{ \begin{matrix}1 & if {g}_{j} = 0 \\ 0 & otherwise\end{matrix} \qquad ( 14 )$$

then {gⱼ₋ₘ, gⱼ} is said to be a transmit-receive pair of length m if gⱼ₋ₘg̅ⱼ=1. As an example, a pair of length m=5 is shown in FIG. 22a. The pair length can be understood as the time difference between the transmit and receive intervals or the distance a wave travels between those intervals.

FIG. 23 shows an example of a sequence G (from FIG. 22c) and the time-of-flight and travel distance of the waves generated by some transmit elements of G. For example, the distance a wave that was generated in g₀ travels, and its time-of-flight, are shown with dotted arrows. This wave reflects back from reflectors 1 and 2. The first reflection arrives at g₃, so this reflector location is said to require a pair of length m=3 to recover the reflection. Equally, the second reflection arrives at g₆ and hence this reflector is said to require a pair m=6. A transmit-receive pair may not exist for a given transmit interval and reflector location, for example, {g₀, g₆} is not a valid pair because in this particular case g₀ g̅₆=0 and hence the reflection will not be received.

### Random Distribution of Receive and Transmit Intervals for Even Sampling of the Medium

In a pulse echo system it is important to ensure equal sensitivity to reflectors regardless of their location in the interrogated space. This is equivalent to obtaining the same number of reflections r, i.e. the same amount of energy and eventually the same SNR, irrespective of the location of the reflectors within a finite distance. More formally, this is to obtain the same number of reflections r for any transmit-receive pair of length m up to a length M.

It should be noted that this condition can be approximately satisfied by any random binary sequence G when L is large and L»M. To prove this, let the expected number of reflections for each transmit-receive pair of length m be

$${r}_{m} = E [ {\sum }_{j = m}^{L} {g}_{j - m} {\overline{g}}_{j} ] m ∈ [ 1 , M ] . \qquad ( 15 )$$

Let p₁ be the probability of having a transmit interval defined as

p₁=E[gⱼ]=1−E[g̅ⱼ̅]. (16)

As every gⱼ equation (15) is i.i.d.,

rₘ=p₁(1−p₁)(L−m) m∈[1,M]. (17)

### Then if L>>M,

r=p₁(1−p₁)L≈rₘ|_{L>>M}. (18)

### Optimal Ratio of Transmit and Receive Intervals

Having discussed that a random distribution of transmit-receive intervals guarantees that the same number of reflections r be received irrespective of the reflector location within a finite distance, the next step is to investigate the optimal number or proportion of transmit-receive intervals in a sequence, i.e. find the optimal p₁. The optimal number of transmit intervals p₁L is that which yields the maximum SNR for a given sequence G of length L. To obtain the SNR of a sequence with receive intervals, the total received energy, the noise from the sequence and the added noise at the receiver need to be found.

To estimate the sample variance after the cross-correlation of a random se-quence Y, σ_{YG}², the steps from equations (6) to (10) can be repeated; as before Y can be understood as the noise added at the receiver. When M is large, σ_{YG}². can be approximated as

$${σ}_{YG}^{2} \approx \frac{1}{M} {\sum }_{k = 1}^{M} {e}_{k}^{2} \approx E [ {e}_{k}^{2} ] L ≫ M . \qquad ( 19 )$$

Note that the factor of 2 has been dropped with respect to equation (6) because M<<L shifts are used to obtain σ_{YG}² and therefore the tapering effect of the correlation can be neglected.

$$E [ {e}_{k}^{2} ] = {\sum }_{j = 0}^{L - k - 1} E [ {z}_{j}^{2} {\overline{g}}_{j + k} {y}_{j + k}^{2} ] , k ∈ [ 1 , M ] , \qquad ( 20 )$$

where zⱼ=xⱼgⱼ are the elements of the transmitted sequence Z and g̅ⱼyⱼ are the elements of the received sequence; note that g̅_{j⋅}²=g̅ⱼ. Finally

σ_{YG}²≈rσ² L>>M. (21)

Now the sample variance of the noise introduced by the sequence itself is investigated following the same steps. Say M is large, then

$$\begin{matrix}{σ}_{SG}^{2} \approx \frac{1}{M} {\sum }_{k = 1}^{M} {f}_{k}^{2} \approx E [ {f}_{k}^{2} ] L ≫ M & ( 22 ) \\ E [ {f}_{k}^{2} ] = {s}^{2} {\sum }_{j = m}^{L - k - 1} E [ {z}_{j}^{2} {\overline{g}}_{j + k} {z}_{j - m + k}^{2} ] , m ∈ [ 1 , M ] , & ( 23 )\end{matrix}$$

where zⱼ₋ₘs=g_{j-mXj-m}s are the elements of the reflected sequence (i.e. the transmitted sequence zⱼ scaled by s and shifted by m) while the actual received sequence is g̅_{jZj-m}s. Note that

σ_{SG}²≈p₁rs² L>>M. (24)

According to equation (18), r reflections are received and since each reflection has amplitudes, the total received energy at shift k=m is approximately (r·s)² when L>>M. Hence, when M is large and L»M,

$${SNR}_{gaps} \approx \frac{{( r \cdot s )}^{2}}{{σ}_{SG}^{2} + {σ}_{YG}^{2}} \approx \frac{r}{{p}_{1} + \frac{1}{{SNR}_{in}}} . \qquad ( 25 )$$

FIG. 24 shows SNR_{gaps} vs. p₁ for different SNRᵢ; L has been set to 10⁴ with the aim of providing a numerical example. There are two extreme cases of interest

$${SNR}_{gaps} \approx \{ \begin{matrix}r \cdot {SNR}_{in} & if {SNR}_{in} ≪ \frac{1}{{p}_{1}} \\ ( 1 - {p}_{1} ) L & if {SNR}_{in} ≫ \frac{1}{{p}_{1}}\end{matrix} \qquad ( 26 )$$

Note that max {r}=0.25 L, which occurs for ₚ₁=0.5. Then max {SNR_{gaps}}ISNR_{in <<2}=0.25L·SNRᵢₙ. Conversely, if

$${SNR}_{in} » \frac{1}{{p}_{1}} ,$$

SNR_{gaps} is independent of SNRᵢₙ, and if SNRᵢₙ is high, it may happen that SNRᵢₙ>SNR_{gaps}, in which case the use of the sequences is detrimental.
Moreover, SNR_{gaps} is a concave function of p₁ for any SNRᵢₙ<∞. Then there exists a value of p₁ that maximises SNR_{gaps} for each SNRᵢₙ.

$${p}_{1 , max} = arg {max}_{{p}_{1}} \{ {SNR}_{gaps} \} \leq 0.5 \qquad ( 27 )$$

and hence the maximum SNR_{gaps} is

$${SNR}_{gaps , max} \approx \frac{( 1 - {p}_{1 , max} ) L}{1 + \frac{1}{{p}_{1 , max} {SNR}_{in}}} . \qquad ( 28 )$$

The figure of merit of the sequence F was not included in equation (25) because this equation is intended to be used with random sequences that do not have any predefined structure and for which F≈1 when L is large. This is because we conjecture that it should be difficult to obtain a sequence that produces F>1 when random receive intervals are used due to the structure of the transmitted sequence being affected by these intervals.

Finally, it is worth mentioning that sequences whose elements take values +1, −1 and 0 as in FIG. 22c have been reported in the literature and are known as ternary sequences [50-52]. However, the insertion of the zeroes aims to improve the sequence autocorrelation properties and is not initially intended for reception to take place. Furthermore, these sequences do not necessarily satisfy p₁=0.5, which is required when SNRᵢₙ<<2.

SNR of Sequences with Receive Intervals and Averaging

Now the ratio of the SNR obtained with the sequences with receive intervals and the SNR obtained with averaging is investigated. As before, transmit and receive intervals are considered of equal length without loss of generality. When L is large this ratio can be approximated as

$$α = \frac{{SNR}_{gaps , max}}{{SNR}_{avg}} \approx \frac{1 - {p}_{1 , max}}{t ( {SNR}_{in} + \frac{1}{{p}_{1 , max}} )} , \qquad ( 29 )$$

where

$$t = \frac{N}{L} ;$$

is the ratio of the number of transmit intervals, N, and the total number of (transmit and receive) intervals, L, when averaging.

FIG. 25 shows the values of t and SNRᵢₙ for which α≈. For any combination of t and SNRᵢₙ values below the curve, α>1, i.e. the sequences with receive intervals produce a greater SNR; otherwise, averaging produces a higher SNR. A desired t for a given SNRᵢₙ may not be achieved when averaging due to many receive intervals being required to avoid interference between transmissions, e.g. when wave reverberations inside the specimen are significant.

Consider the extreme case in equation (29) where SNRᵢₙ<<2, and for which p₁=0.5 is known to be optimal, then

$$α {\vert}_{{SNR}_{in} ≪ 2 , {p}_{1} = 0.5} \approx \frac{1}{4 t} . \qquad ( 30 )$$

This means that when more than 3 receive intervals are required per transmit interval to avoid interference when averaging, the sequence with gaps produce a greater SNR. Finding scenarios where there is no interference using 3 or less receive intervals when averaging is rare in practice. A common scenario in pulse-echo ultrasound systems is to use more than 40 receive intervals when averaging, i.e. the receiver is on for 40 times the transmit length, to avoid interference due to reverberations in the specimen. In such a case the SNR achieved by the sequence is at least 20 dB greater (when SNRᵢₙ<<2 and p₁=0.5).

Periodic Sequences with Receive Intervals: Continuous Transmission

Let the sequence \hat{Z} be infinite with period L and elements

\hat{Z}_{j+q}L=zⱼ j∈[0,L−1]

where q is an integer and the elements zⱼ are defined in equation (13). In the same way ĝⱼ can be defined from gⱼ.

Say \hat{Z} is transmitted and the received signal is cross-correlated with \hat{Z} shifted by n. The expected value of the cross-correlation of a finite number of samples

L is then

$$\begin{matrix}E [ {\hat{f}}_{k , n} ] = s {\sum }_{j = 0}^{L - 1} E [ {\hat{z}}_{j - n} {\overline{\hat{g}}}_{j - n + k} {\hat{z}}_{j - m + k} ] \\ = \{ \begin{matrix}r \cdot s & k = m - n + qL \\ 0 & otherwise\end{matrix} ,\end{matrix} \\ m , k ∈ [ 1 , L - 1 ] . \qquad ( 31 )$$

Since \hat{Z} and Ĝ have period L, for every n there exists a value of k in the interval [1, L−1] for which E┌\hat{f}_{k,n}┐=r·s. This means that the sequence \hat{Z} can be transmitted continuously and at any instant n reflections within a time-of-flight of m<L−1 can be recovered after cross-correlating L received elements. Note the same SNR_{gaps} is obtained when replacing Z by \hat{Z}.

By transmitting a sequence with finite period L, a significant amount of memory and computing power is saved but the time-of-flight of the furthest reflection has to be less than L−1 to prevent these reflections from being seen as coherent interference. This is equivalent to waiting for the energy in a specimen to die out between transmissions when using averaging. The importance of being able to transmit/receive continuously is that it significantly reduces any delays in the system when processing the sequences, which then reduces the time the system takes to respond to changes in the medium.

### Application Example: Fast Low-Power EMAT

In this section a sequence with reception gaps was applied to industrial ultra-sound. The example consists in an electromagnetic-acoustic transducer (EMAT) being driven with only 4.5 Vpp and less than 0.5 W. The main advantage of using EMATs is that, unlike standard piezoelectric transducers, they do not require direct contact with the specimen. However, EMATs are notorious for requiring very high excitation voltages, commonly in excess of a few hundred volts and powers greater than 1 kW [53-57]. In certain scenarios high powers are not permissible, e.g. in explosive environments, such as refineries, or where compact/miniaturised electronics is required; high-power electronics requires bigger components and more space to dissipate the heat. The use of sequences with reception gaps presented in this paper is key in these scenarios to reduce the excitation power while keeping the overall duration of the measurement short.

The performance of a low-power custom-made system that uses sequences with reception gaps will be compared against a state-of-the-art high-power system (PowerBox H, Innerspec, USA). It will be shown that similar performance can be achieved but with more than 20 dB reduction in transmitted power in quasi-real-time. By quasi-real-time the authors mean that the overall duration of the measurement does not affect the results or the way it is conducted.

### Experimental Setup

The experiment setup is shown in FIG. 26a-b. An EMAT (Part No. 274A0272, Innerspec, USA) was placed on top of a mild steel block, which had a thickness of 20 mm. This is a pancake coil EMAT that generates radially polarised shear waves within a circular aperture, which has an outer diameter of roughly 20 mm. The main objective of this setup is to obtain a signal that can be used to estimate the thickness of the steel block. In this particular case it is convenient to use the coded sequences with reception gaps because a) the steel block offers low attenuation to the wave and b) the front- and back-walls of the specimen trap all the reflections and therefore the wave reverberates inside the specimen for a long time. This implies that many averages cannot be used to reduce the power and/or increase the SNR because of the significant wait time between transmissions required to prevent coherent interference between subsequent transmissions.

A custom made transmit-receive electronic circuit was developed for the experiment. This circuit was solely powered by the USB port of a standard personal computer (PC), which can deliver a maximum of 5 V and 1A, i.e. less than 5 W. The electronics consists of a balanced transmitter with a maximum output voltage of 4.5 Vpp (peak-to-peak) and maximum output current of 150 mA, hence the maximum peak power is less than 0.34 W. The receiver provided a gain of roughly 60 dB and both transmitter and receiver have a bandwidth greater than 5 MHz.

A device (Handyscope-HS5, TiePie, Netherlands) that consists of a signal generator and an analog-to-digital converter (ADC) was employed to drive the custom-made transmitter (driver) and to digitise the output of the custom-made receive amplifier. The Handyscope-HS5 communicates with a PC via the USB port. Both the signal generator and the ADC of the Handyscope-HS5 were sampled at 100 MHz.

In a second setup, the EMAT was connected to the transmit-receive system (PowerBox H, Innerspec, USA) provided by the manufacturer of the EMAT; the EMAT position on the steel block was not changed. This setup is not shown for the sake of brevity. The PowerBox H was set to drive the EMAT at 1200 Vpp, which according to the manufacturer can produce a peak power of 8000 W. A 3-cycle pulsed burst at a central frequency of 2.5 MHz was transmitted. The number of averages in the system was set to zero and the repetition rate to 30 bursts per second to avoid any interference from subsequent excitations. The receive amplifier gain was set to 60 dB.

### Results

The signals obtained using the transmit-receive system (PowerBox H, Innerspec, USA) were match-filtered with a 3-cycle Hanning window centred at 2.5 MHz; this is to produce a fair comparison with the cross-correlation output of the sequences. The output of the filter is shown in FIG. 27a. Multiple echoes that correspond to the back and front walls of the steel block can be observed to decay progressively. Coherent noise can also be found between the echoes, as shown in the figure.

This coherent noise is a result of waves that mode-convert at the walls of the specimen, e.g. from shear to longitudinal waves and vice versa, which travel at a different speed to that of the main echoes. Coherent noise cannot be removed by averaging or using the coded sequences. In the figure, the coherent noise is dominant over any electrical random noise that could not be completely removed after the match-filter was applied; therefore, there is not much gain in increasing the transmitted power further because the coherent noise will increase proportionally.

To drive the custom-made electronics, shown in FIG. 26b), a sequence of length 2¹⁴ (16384) was generated with equal number of receive and transmit intervals randomly distributed. Each burst consisted of a 3-cycle Hanning window centred at 2.5 MHz, this is similar to the excitation used for the PowerBox H; the polarisation of the bursts follows a uniform distribution. After the excitation of the bursts a wait time of 5 times the burst duration was added to the transmission intervals of the sequences, hence the overall transmission interval is 6 times the burst duration (7.2 μs); a transmission interval of 7.2 μs produces a blind region of 10 mm within a steel specimen when using shear wave transducer. This was necessary to allow for the energy in the transducer to die out, so that the receive electronics does not saturate. Then, the total duration of the sequence was 118 ms. The authors argue that a system that processes the data at this rate can be considered as quasi-real-time for inspections that use hand-held transducers.

The received signals were zero-masked at the transmission intervals, to eliminate any noise introduced during this stage, and correlated with the transmitted sequence. The results are shown in FIG. 27b. The first echoes can be clearly recognised from the noise threshold. In general, the noise level of FIG. 27b appears to be, by visual inspection, greater than that of FIG. 27a. This noise could either be, coherent noise introduced by the sequence or random electrical noise. The latter being mainly due to the receive amplifier.

To further investigate the origin of the noise, the steel block response to the excitation was simulated by delaying and scaling the sequences by the corresponding approximate value and then superimposing the results. FIG. 27c shows the results with added random noise, which had a standard deviation 10 times greater than the amplitude of the received bursts. FIG. 27d shows the results without added noise. By comparing FIGS. 27c and d, it can be concluded that the main source of the noise is the random electrical noise introduced by the receive amplifier.

### Discussion of Results

The main conclusion from the experiments is that a significant power reduction in the excitation can be obtained by using coded sequences with reception gaps while still being able to obtain a quasi-real-time response. Note that had averaging been used with the custom-made electronics, they wait-time between transmissions would have been more than 100 μs and the number of averages needed 2¹², which corresponds to a total duration of more than 400 ms (4 times longer than the sequences).

The power delivered by the PowerBox H (Innerspec, USA), was expected to be in the order of 8000 W. A similar signal was obtained by the custom-made electronics driven by a sequence with random gaps using a mere 0.34 W, i.e. a difference of more than 40 dB. We conjecture that, in this particular example, a fairer comparison would be that where the power of the PowerBox H were dropped by 20-23 dB and 100-200 averages used. In such a case, the real advantage of the sequences would be a power reduction of 20-30 dB compared to the PowerBox H. However, that comparison could not be tested because the excitation voltage of the PowerBox H can only be set to either 600 or 1200 Vpp.

The exact power reduction achieved by the custom-made electronics when using the sequences (compared to the PowerBox H) should be interpreted with care because the noise performance of the receive electronics of both systems has a direct impact on the SNR of the received signal; the noise performance of the PowerBox H and the custom-made electronics were not compared. Nonetheless, the SNR increase when using the sequences can be estimated numerically. For example, provided the noise at the input of the receive amplifier is greater than the signal from the reflectors, as confirm in FIG. 27b-c the SNR increase produced by a sequence of length 2¹⁴ with equal numbers of transmit and receive intervals is 2¹² (4096 times or 36.1 dB). In other words, ˜36 dB less power is required compared to a single excitation; this value corresponds to the order of the power reduction that was achieved in the experiments.

It should be highlighted that the above described custom-made electronics is believed to be non-optimal and hence it should be possible to further reduce the noise introduced by the receive amplifier as well as any other source of electrical interference affecting the system, e.g. from the USB power supply. All this will lead to a reduction of the required sequence length or a greater SNR. Another drawback of the custom-made electronics is that the transmission interval was excessively large (6 times the duration of the excitation burst). This was necessary to attenuate any remaining energy in the EMAT coil after the excitation and to avoid the receive amplifier to saturate on reception. The duration of the transmission interval can be reduced with better electronic circuitry.

### CONCLUSIONS

Pulse-compression has been used for decades in pitch-catch systems to increase the SNR without significantly increasing the overall duration of the measurement. Current pulse-compression techniques cannot be used in pulse-echo when a significant SNR increase is needed. This paper presents a solution to that problem, which consists in inserting randomly distributed reception gaps into the coded sequence.

When the input SNR is low, the sequences with reception gaps are much faster than averaging, or equivalently, an approximately 20 dB-higher SNR can be expected in most practical cases for the same overall measurement duration. We also show that under low input SNR, a simple random codification of the sequence, where there are equal number of receive and transmit intervals of equal length randomly distributed, performs optimally. Moreover, a sequence of any given length can be continuously transmitted without pauses, which increases the refresh rate of the system.

An application of these sequences in industrial ultrasound was presented. It was shown that an electromagnetic-acoustic transducer (EMAT) can be driven with 4.5 V obtaining a clear signal in quasi-real-time; commercially available systems require 1200 V for similar performance.

### REFERENCES

[1] A. S. Mudukutore, V. Chandrasekar, and R. J. Keeler, “Pulse compression for weather radars,” Geoscience and Remote Sensing, IEEE Transactions on, vol. 36, no. 1, pp. 125142, 1998.
[2] M. Parlak, M. Matsuo, and J. F. Buckwalter, “Analog signal processing for pulse compression radar in 90-nm cmos,” Microwave Theory and Techniques, IEEE Transactions on, vol. 60, no. 12, pp. 3810 3822, 2012.
[3] K. Nakahira, T. Kodama, T. Furuhashi, and H. Maeda, “Design of digital polarity correlators in a multiple-user sonar ranging system,” Instrumentation and Measurement, IEEE Transactions on, vol. 54, no. 1, pp. 305-310, 2005.
[4] Y.-T. Tseng, J.-J. Ding, and C.-S. Liu, “Analysis of attenuation measurements in ocean sediments using normal incidence chirp sonar,” Oceanic Engineering, IEEE Journal of, vol. 37, no. 3, pp. 533 543, 2012.
[5] D. Maresca, K. Jansen, G. Renaud, G. Van Soest, X. Li, Q. Zhou, N. de Jong, K. K. Shung, and A. Vander Steen, “Intravascular ultrasound chirp imaging,” Applied Physics Letters, vol. 100, no. 4, p. 043703, 2012.
[6] X. Song, D. Ta, and W. Wang, “A base-sequence-modulated golay code improves the excitation and measurement of ultrasonic guided waves in long bones,” Ultrasonics, Ferroelectrics and Frequency Control, IEEE Transactions on, vol. 59, no. 11, 2012.
[7] C.-C. Shen and C.-H. Lin, “Chirp-encoded excitation for dual-frequency ultrasound tissue harmonic imaging,” Ultrasonics, Ferroelectrics and Frequency Control, IEEE Transactions on, vol. 59, no. 11, 2012.
[8] C. Yoon, W. Lee, J. Chang, T.-K. Song, and Y. Yoo, “An efficient pulse compression method of chirp-coded excitation in medical ultrasound imaging,” Ultrasonics, Ferroelectrics, and Frequency Control, IEEE Transactions on, vol. 60, no. 10, pp. 2225-2229, 2013.
[9] T. Harrison, A. Sampaleanu, and R. Zemp, “S-sequence spatially-encoded synthetic aperture ultrasound imaging [correspondence],” Ultrasonics, Ferroelectrics and Frequency Control, IEEE Transactions on, vol. 61, no. 5, pp. 886-890, 2014.
[10] S. Mensah, J. Rouyer, A. Ritou, and P. Lasaygues, “Low-contrast lesion detection enhancement using pulse compression technique,” The Journal of the Acoustical Society of America, vol. 135, no. 4, pp. 2156-2156, 2014.
[11] T. Misaridis and J. A. Jensen, “Use of modulated excitation signals in medical ultrasound. part i: Basic concepts and expected benefits,” Ultrasonics, Ferroelectrics, and Frequency Control, IEEE Transactions on, vol. 52, no. 2, pp. 177-191, 2005.
[12] K. Ho, T. Gan, D. Billson, and D. Hutchins, “Application of pulse compression signal processing techniques to electromagnetic acoustic transducers for noncontact thickness measurements and imaging,” Review of scientific instruments, vol. 76, no. 5, p. 054902, 2005.
[13] M. Mienkina, C.-S. Friedrich, N. Gerhardt, W. Wilkening, M. Hofmann, and G. Schmitz, “Experimental evaluation of photoacoustic coded excitation using unipolar golay codes,” Ultrasonics, Ferroelectrics and Frequency Control, IEEE Transactions on, vol. 57, no. 7, pp. 1583-1593, 2010.
[14] T. Gan, D. Hutchins, D. Billson, and D. Schindel, “The use of broadband acoustic transducers and pulse-compression techniques for air-coupled ultrasonic imaging,” Ultrasonics, vol. 39, no. 3, pp. 181-194, 2001.
[15] M. Ricci, S. Callegari, S. Caporale, M. Monticelli, L. Battaglini, M. Eroli, L. Senni, R. Rovatti, G. Setti, and P. Burrascano, “Exploiting non-linear chirp and sparse deconvolution to enhance the performance of pulse-compression ultrasonic ndt,” in Ultrasonics Symposium (IUS), 2012 IEEE International, pp. 1489-1492, IEEE, 2012.
[16] J. E. Michaels, S. J. Lee, A. J. Croxford, and P. D. Wilcox, “Chirp excitation of ultrasonic guided waves,” Ultrasonics, vol. 53, no. 1, pp. 265-270, 2013.
[17] D. Hutchins, P. Burrascano, L. Davis, S. Laureti, and M. Ricci, “Coded waveforms for optimised air-coupled ultrasonic nondestructive evaluation,” Ultrasonics, 2014.
[18] R. H. Dicke, “Object detection system,” Jan. 6, 1953. U.S. Pat. No. 2,624,876.
[19] M. Ricci, L. Senni, and P. Burrascano, “Exploiting pseudorandom sequences to enhance noise immunity for air-coupled ultrasonic nondestructive testing,” Instrumentation and Measurement, IEEE Transactions on, vol. 61, no. 11, pp. 2905-2915, 2012.
[20] B. Yoo, A. Purekar, Y. Zhang, and D. Pines, “Piezoelectric-paint-based two-dimensional phased sensor arrays for structural health monitoring of thin panels,” Smart Materials and Structures, vol. 19, no. 7, p. 075017, 2010.
[21] R. J. Przybyla, S. E. Shelton, A. Guedes, I. Izyumin, M. H. Kline, D. Horsley, B. E. Boser, et al., “In-air rangefinding with an aln piezoelectric micro-machined ultrasound transducer,” Sensors Journal, IEEE, vol. 11, no. 11, pp. 2690-2697, 2011.
[22] C. De Marziani, J. Urena, Á. Hernández, M. Mazo, F. J. Alvarez, J. J. Garcia, and P. Donato, “Modular architecture for efficient generation and correlation of complementary set of sequences,” Signal Processing, IEEE Transactions on, vol. 55, no. 5, pp. 2323-2337, 2007.
[23] M. C. Perez, J. Urena, Á. Hernández, A. Jiménez, and C. De Marziani, “Efficient generation and correlation of sequence pairs with three zero-correlation zones,” Signal Processing, IEEE Transactions on, vol. 57, no. 9, pp. 3450-3465, 2009.
[24] P. Stoica, H. He, and J. Li, “New algorithms for designing unimodular sequences with good correlation properties,” Signal Processing, IEEE Transactions on, vol. 57, no. 4, pp. 1415-1425, 2009.
[25] H. He, P. Stoica, and J. Li, “On aperiodic-correlation bounds,” Signal Processing Letters, IEEE, vol. 17, no. 3, pp. 253-256, 2010.
[26] M. Baldi, F. Chiaraluce, N. Boujnah, and R. Garello, “On the autocorrelation properties of truncated maximum-length sequences and their effect on the power spectrum,” Signal Processing, IEEE Transactions on, vol. 58, no. 12, pp. 6284-6297, 2010.
[27] M. Soltanalian and P. Stoica, “Computational design of sequences with good correlation properties,” Signal Processing, IEEE Transactions on, vol. 60, no. 5, pp. 2180-2193, 2012.
[28] E. Garcia, J. Urena, and J. J. Garcia, “Generation and correlation architectures of multilevel complementary sets of sequences,” Signal Processing, IEEE Transactions on, vol. 61, no. 24, pp. 6333-6343, 2013.
[29] W. Nam and S.-H. Kong, “Least-squares-based iterative multipath super-resolution technique,” Signal Processing, IEEE Transactions on, vol. 61, no. 3, pp. 519-529, 2013.
[30] M. Soltanalian, M. M. Naghsh, and P. Stoica, “On meeting the peak correlation bounds,” Signal Processing, IEEE Transactions on, vol. 62, no. 5, pp. 1210-1220, 2014.
[31] J. Song, P. Babu, and D. Palomar, “Sequence design to minimize the weighted integrated and peak sidelobe levels,” 2015.
[32] J. Song, P. Babu, and D. P. Palomar, “Optimization methods for designing sequences with low autocorrelation sidelobes,” Signal Processing, IEEE Transactions on, vol. 63, no. 15, pp. 3998-4009, 2015.
[33] K. Li, L. Gan, and C. Ling, “Convolutional compressed sensing using de-terministic sequences,” Signal Processing, IEEE Transactions on, vol. 61, no. 3, pp. 740-752, 2013.
[34] M. J. Golay, “Complementary series,” Information Theory, IRE Transactions on, vol. 7, no. 2, pp. 82-87, 1961.
[35] C.-C. Tseng and C. Liu, “Complementary sets of sequences,” Information Theory, IEEE Transactions on, vol. 18, no. 5, pp. 644-652, 1972.
[36] R. Sivaswamy, “Multiphase complementary codes,” Information Theory, IEEE Transactions on, vol. 24, no. 5, pp. 546-552, 1978.
[37] J. M. Jensen, H. E. Jensen, and T. Hoholdt, “The merit factor of binary sequences related to difference sets,” Information Theory, IEEE Transactions on, vol. 37, no. 3, pp. 617-626, 1991.
[38] L. Xu and Q. Liang, “Zero correlation zone sequence pair sets for mimo radar,” Aerospace and Electronic Systems, IEEE Transactions on, vol. 48, no. 3, pp. 2100-2113, 2012.
[39] Z. Liu, Y. L. Guan, and W. H. Mow, “A tighter correlation lower bound for quasi-complementary sequence sets,” Information Theory, IEEE Transactions on, vol. 60, no. 1, pp. 388-396, 2014.
[40] P. Borwein, K.-K. S. Choi, and J. Jedwab, “Binary sequences with merit factor greater than 6.34,” Information Theory, IEEE Transactions on, vol. 50, no. 12, pp. 3234-3249, 2004.
[41] J. Jedwab, “A survey of the merit factor problem for binary sequences,” in Sequences and Their Applications-SETA 2004, pp. 30-55, Springer, 2005.
[42] J. Jedwab, “What can be used instead of a barker sequence?,” Contemporary Mathematics, vol. 461, pp. 153-178, 2008.
[43] R. H. Barker, “Group synchronization of binary digital systems in communication theory,” Academic Press, New York, 1953.
[44] K. H. Leung and B. Schmidt, “The field descent method,” Designs, Codes and Cryptography, vol. 36, no. 2, pp. 171-188, 2005.
[45] T. Hoholdt and H. E. Jensen, “Determination of the merit factor of legendre sequences,” Information Theory, IEEE Transactions on, vol. 34, no. 1, pp. 161-164, 1988.
[46] S. W. Golomb and G. Gong, Signal design for good correlation: for wireless communication, cryptography, and radar. Cambridge University Press, 2005.
[47] H. Torii, M. Nakamura, and N. Suehiro, “A new class of zero-correlation zone sequences,” Information Theory, IEEE Transactions on, vol. 50, no. 3, pp. 559-565, 2004.
[48] P. Fan, W. Yuan, and Y. Tu, “Z-complementary binary sequences,” Signal Processing Letters, IEEE, vol. 14, no. 8, pp. 509-512, 2007.
[49] M. J. Golay, “Sieves for low autocorrelation binary sequences,” Information Theory, IEEE Transactions on, vol. 23, no. 1, pp. 43-51, 1977.
[50] T. Hoholdt and J. Justesen, “Ternary sequences with perfect periodic auto-correlation (corresp.),” Information Theory, IEEE Transactions on, vol. 29, no. 4, pp. 597-600, 1983.
[51] A. Gavish and A. Lempel, “On ternary complementary sequences,” Information Theory, IEEE Transactions on, vol. 40, no. 2, pp. 522-526, 1994.
[52] R. Craigen and C. Koukouvinos, “A theory of ternary complementary pairs,” Journal of Combinatorial Theory, Series A, vol. 96, no. 2, pp. 358-375, 2001.
[53] P. D. Wilcox, M. J. Lowe, and P. Cawley, “The excitation and detection of lamb waves with planar coil electromagnetic acoustic transducers,” Ultrasonics, Ferroelectrics, and Frequency Control, IEEE Transactions on, vol. 52, no. 12, pp. 2370-2383, 2005.
[54] R. Ribichini, F. Cegla, P. B. Nagy, and P. Cawley, “Study and comparison of different emat configurations for sh wave inspection,” Ultrasonics, Ferroelectrics, and Frequency Control, IEEE Transactions on, vol. 58, no. 12, pp. 2571-2581, 2011.
[55] H. Gao, S. Ali, and B. Lopez, “Efficient detection of delamination in multilayered structures using ultrasonic guided wave emats,” NDT & E Inter-national, vol. 43, no. 4, pp. 316-322, 2010.
[56] F. Li, D. Xiang, Y. Qin, R. B. Pond, and K. Slusarski, “Measurements of degree of sensitization (dos) in aluminum alloys using emat ultrasound,” Ultrasonics, vol. 51, no. 5, pp. 561-570, 2011.
[57] K. Mirkhani, C. Chaggares, C. Masterson, M. Jastrzebski, T. Dusatko, A. Sinclair, R. J. Shapoorabadi, A. Konrad, and M. Papini, “Optimal design of emat transmitters,” NDT & E International, vol. 37, no. 3, pp. 181-193, 2004.

1. A method of echo measurement comprising:
transmitting a transmitted-signal modulated over a modulation duration;
receiving a received-signal; and
cross correlating said received-signal with said transmitted-signal, wherein
said transmitting comprises a plurality of transmission periods separated by a plurality of transmission pauses;
said modulation duration extends over two or more of said plurality of transmission periods; and
duration of said transmission pauses is varied within a range of transmission pause duration.

2. A method as claimed in claim 1, wherein said cross correlating determines a waveform from which are extracted one or more of:
a time of flight of said received-signal;
an amplitude of said received-signal; and
a phase of said received-signal.

3. A method as claimed in claim 1, wherein said duration of said transmission pauses is varied within said range of transmission pause duration such that at least one of said transmission pauses includes a time corresponding to a time of receipt of a received-signal of any given time of flight within a measured range of time of flight.

4. A method as claimed in claim 3, wherein said modulation duration is greater than a minimum within said measured range of time of flight.

5. A method as claimed in claim 1, wherein said transmitting and said receiving are spatially proximate.

6. A method as claimed in claim 1, wherein said transmitting and said receiving are performed by a common transducer.

7. A method as claimed in claim 1, wherein one of:
said transmitted-signal is modulated to transmit a coded sequence with an overall code length extending over two or more transmission periods; and
said transmitted-signal is chirp modulated with a chirp modulation duration extending over two or more transmission periods.

8. A method as claimed in claim 1, wherein said transmitted-signal is one or more of:
frequency modulated;
amplitude modulated; and
phase modulated.

9. A method as claimed in claim 1, comprising transmitting N at least substantially orthogonally modulated transmitted-signals, where N is an integer greater than one, receiving M received-signals, where M is an integer greater than one, and cross correlating said M received-signals with respective ones of said N transmitted-signals to provide N*M independent measurement channels.

10. A method as claimed in claim 9 wherein N=M and said transmitting and said receiving are performed by N common transducers.

11. A method as claimed in claim 1, wherein one of:
said transmitted-signal is a transmitted acoustic wave signal and said received-signal is a received acoustic wave signal;
said transmitted-signal is a transmitted elastic wave signal and said received-signal is a received elastic wave signal; and
said transmitted-signal is a transmitted electromagnetic signal and said received-signal is a received electromagnetic signal.

12. A method as claimed in claim 1, wherein said duration of said transmission pauses is one of:
randomly varied within a range of transmission pause duration; and
varied in accordance with a predetermined sequence within said range of transmission pause duration.

13. A method as claimed in claim 1, wherein said receiving comprises a linear 1-bit digitization of said received-signal.

14. A method as claimed in claim 13, wherein said receiving is performed using an analog receiver channel supplying an analog signal to digital bus of a digital sampling circuit and a sample frequency of said analog channel receiver is equal to or less than a bus frequency of said digital bus.

15. A method as claimed in claim 14, wherein said analog signal is directly connected to a digital signal line of said digital bus.

16. A method as claimed in claim 14, said analog signal is connected to a comparator and said comparator is connected to a digital signal line of said digital bus.

17. A method as claimed in claim 14, said analog signal is connected to a comparator, said comparator is connected to a digital signal latch and said digital signal latch is connected to a digital signal line of said digital bus.

18. Apparatus for echo measurement comprising:
a transmitter to transmit a transmitted-signal modulated over a modulation duration;
a receiver to receive a received-signal; and
correlation circuitry to cross correlate said received-signal with said transmitted-signal, wherein
said transmitter is configured to transmit during a plurality of transmission periods separated by a plurality of transmission pauses;
said modulation duration extends over two or more of said plurality of transmission periods; and
duration of said transmission pauses is varied within a range of transmission pause duration.

19.-33. (canceled)

34. Apparatus for echo measurement comprising:
means for transmitting a transmitted-signal modulated over a modulation duration;
means for receiving a received-signal; and
means for cross correlating said received-signal with said transmitted-signal, wherein said means for transmitting is configure to transmit during a plurality of transmission periods separated by a plurality of transmission pauses;
said modulation duration extends over two or more of said plurality of transmission periods; and
duration of said transmission pauses is varied within a range of transmission pause duration.
